(19) United States
(12) Patent Application Publication
(10) Pub. No.: US 2017/0092922 A1
(43) Pub. Date: Mar. 30, 2017

(54) NON-AQUEOUS ELECTROLYTE BATTERY

(71) Applicant: Sony Corporation, Tokyo (JP)

(72) Inventors: Hayato Hommura, Kanagawa (JP); Hiroshi Imoto, Kanagawa (JP); Atsuo Omaru, Fukushima (JP); Masayuki Nagamine, Fukushima (JP); Akira Yamaguchi, Fukushima (JP)

(21) Appl. No.: 15/374,730

(22) Filed: Dec. 9, 2016

Related U.S. Application Data
(62) Division of application No. 10/467,537, filed on Jan. 29, 2004.

(30) Foreign Application Priority Data
Feb. 14, 2001 (JP) 2001-037452
Mar. 16, 2001 (JP) 2001-076913

(51) Int. Cl. H01M 2/16; H01M 10/0525

(52) U.S. Cl. CPC H01M 2/1686; H01M 2/1653; H01M 10/0525

(57) ABSTRACT

A nonaqueous electrolyte battery with a spirally coiled electrode body (10) including a cathode (11) having a cathode active material and an anode (12) having an anode active material which are coiled through a separator (13) in a battery can (1). As the separator (13), is used a separator having a plurality of laminated microporous films made of polyolefin which have different film layer thickness and average pore size. Specially, the separator (13) has three or more layers of microporous films made of polyolefin laminated. Further, the outermost layer of the separator is made of porous polypropylene and at least one layer of inner layers is made of porous polyethylene. The total of the thickness of layers made of porous polyethylene is located within a range of 40% to 84% as thick as the thickness of the separator. Thus, the temperature of a battery can be controlled, a reliability is enhanced and a productivity and cyclic characteristics are improved.

### RELATED APPLICATION DATA

This application is a divisional of U.S. patent application Ser. No. 10/467,537 filed Jan. 29, 2004, the entirety of which is incorporated herein by reference to the extent permitted by law. U.S. patent application Ser. No. 10/467,537 is the Section 371 National Stage of PCT/JP02/01204 filed Feb. 13, 2002. The present application claims the benefit of priority to Japanese Patent Application Nos. JP 2001-037452 filed on Feb. 14, 2001 and JP 2001-076913 filed on Mar. 16, 2001 in the Japan Patent Office, the entireties of which are incorporated by reference herein to the extent permitted by law.

### TECHNICAL FIELD

The present invention relates to a nonaqueous electrolyte battery including a cathode having a cathode active material, an anode, a nonaqueous electrolyte and a separator. More particularly, the present invention relates to a nonaqueous electrolyte battery in which the separator has a multilayer structure.

### BACKGROUND ART

In recent years, many portable electronic devices such as video cameras with VTRs (Video Tape Recorder), portable telephones, lap top computers, etc. have appeared on the stage. In accordance with the outstanding progress of electronic technology, these electronic devices have been actually made to be compact and light in turn. Thus, the research and development for improving the energy density of batteries, especially, secondary batteries have been vigorously advanced as the portable power sources of the electronic devices.

For instance, since a lithium-ion secondary battery among them can obtain the energy density higher than that of a nickel-cadmium battery as a conventional aqueous electrolyte secondary battery, the success of the lithium-ion secondary battery has been anticipated.

Here, for instance, as separators for the nonaqueous electrolyte batteries such as the lithium-ion secondary batteries, there have been widely employed microporous films made of polyolefin such as high molecular weight polyethylene, high molecular weight polypropylene, etc. These separators respectively have a shut-down effect as a safety mechanism that when the internal temperature of the battery reaches about 120° C. to 170° C., the microporous film made of polyolefin and having a suitable air permeability generates a endothermic reaction to be melted, so that fine pores are closed to prevent electric current from being supplied.

Further, as the separators for the nonaqueous electrolyte batteries such as the lithium-ion secondary batteries, there have been employed microporous films made of polyolefin such as polyethylene, polypropylene, etc. As the microporous films made of polyolefin used as the separators for the nonaqueous electrolyte batteries, there may be employed films in which the each pore size is located within a range of 0.05 μm to 1 μm and a porosity is 45% or so, which is different depending on their materials. As described above, since the separator has many pores, electrolyte solution enters these pores. When the battery is charged and discharged, lithium ions comes and goes between a cathode and an anode through the electrolyte solution.

However, as a first problem, although circumstances are different depending on materials, when the temperature of the microporous film made of polyolefin used as the separator for the nonaqueous electrolyte battery reaches shut-down temperature, and further reaches to melt-down temperature as a result of being exposed to an environment in which the temperature of the battery becomes high, there is a fear that the microporous film may be possibly melted and flow out. In this case, in the nonaqueous electrolyte battery, a short-circuit due to the physical contact of the cathode and the anode is generated.

For instance, since the melting point of polyethylene is low, when the separator is composed of a single layer of polyethylene, the melt-down is apt to be generated. Further, since the separator made of a polyethylene single layer is low in its strength, specially, piercing strength, there is a fear that the separator may be possibly pierced and broken so that a short-circuit due to the physical contact of the cathode and the anode is generated. This may possibly lead to the deterioration of reliability of the battery. Here, the piercing strength designates a maximum value of strength obtained when the separator is compressed by a pin at prescribed speed and the separator is finally broken.

On the other hand, when the separator is composed of a single layer of polypropylene, since the melting point of polypropylene is high, the melt-down is hardly generated and polypropylene is stronger than polyethylene in view of strength. However, since the shut-down of polypropylene is generated at temperature as high as 170° C. or higher near the melting point of lithium, even if the current of the battery is cut off by the shut-down effect, when lithium generates heat as a result of melting due to heat generated in the battery, the heat absorption by the separator cannot come up with the heat generation so that the temperature of the battery may not be possibly assuredly controlled.

That is, under existing circumstances, has not been yet established a nonaqueous electrolyte battery excellent in its reliability in which the temperature of the battery can be assuredly controlled and a possibility of generation of the short-circuit is low.

As a second problem, when the each pore size of the separator is large, active materials falling from the surfaces of the anode and the cathode enter the pores of the separator to easily generate an internal short-circuit. As a result, the percent defective of the battery is inconveniently increased upon production.

Thus, a method for reducing the each pore size of the separator is considered. However, when the pore size is simply reduced, the electrolyte solution supplied from the separator becomes undesirably insufficient on the surfaces of the electrodes of the battery, so that lithium ions scarcely come and go between the cathode and the anode upon charging and discharging the battery, and accordingly, cyclic characteristics are deteriorated.

### DISCLOSURE OF THE INVENTION

It is a first object of the present invention to provide a nonaqueous electrolyte battery excellent in its reliability in which the temperature of the battery can be controlled. It is a second object of the present invention to provide a nonaqueous electrolyte battery excellent in both productivity and cyclic characteristics.

A nonaqueous electrolyte battery according to the present invention comprises a cathode having a cathode active material, an anode having an anode active material, a nonaqueous electrolyte and a separator disposed between the cathode and the anode, wherein the separator has a plurality of microporous films made of polyolefin laminated and the plural microporous films include a first microporous film and a second microporous film in which the thickness of layers or the average pore size of the pores of the films to be laminated is respectively different from each other.

In this case, at least one layer of the plural microporous films in the separator is a microporous film made of polypropylene.

Especially, in order to achieve the first object, in the nonaqueous electrolyte battery according the present invention, the separator may have three or more layers of microporous films made of polyolefin laminated, the outermost layer of the separator may be made of porous polypropylene, at least one layer of inner layers sandwiched in between the outermost layers may be made of porous polyethylene, and the total of the thickness of the layers made of the porous polyethylene may be located within a range of 40% to 84% as thick as the thickness of the separator.

According to the nonaqueous electrolyte battery according to the present invention with such a construction, the separator has a sufficient strength, and even when the internal temperature of the battery rises due to an external short-circuit or the like, the separator absorbs heat in the battery to suppress a chemical reaction in the battery, so that the internal temperature of the battery is assuredly lowered.

Further, the separator preferably has the thickness located within a range of 15 μm to 40 μm and the thickness of the outermost layer of the microporous films forming the separator may be 2 μm or more. The rate of the pore volume of the microporous films relative to the entire volume of the microporous films forming the separator may be located within a range of 30% to 50%.

Further, the melting point of porous polyethylene of which the inner layers are made may be located within a range of 130° C. to 135° C., and more preferably located within a range of 120° C. to 135° C. The average particle size of the cathode active material is preferably located within a range of 3 μm to 30 μm. Further, the 90% cumulative pore size of the microporous films as the separator is preferably located within a range of 0.02 μm to 2 μm and the average particle size of the cathode active material is preferably located within a range of 3 μm to 30 μm.

In order to achieve the second object, in the nonaqueous electrolyte battery according to the present invention, the separator is composed of two laminated layers of microporous films made of polyolefin and the average pore size of the microporous film in the cathode side is larger than the average pore size of the microporous film in the anode side. Specially, one of the microporous films constituting the separator is made of polypropylene and it is used as the separator in the anode side and the other is made of polyethylene and it is used as the separator in the cathode side. In this case, as the anode, is used an anode including a material capable of being doped with or dedoped from lithium. Further, assuming that the average pore size of the microporous film in the cathode side is A and the average pore size of the microporous film in the anode side is B, the ratio of the average pore size A to B may be located within a range of 1.2 or larger and 10 or smaller.

In the nonaqueous electrolyte battery according to the present invention, the average pore size of the microporous film in the anode side may be larger than the average pore size of the microporous film in the cathode side and the microporous film in the cathode side may be made of polypropylene. In this case, is used the anode including a material capable of being doped with and dedoped from lithium. Further, assuming that the average pore size of the microporous film in the cathode side is C and the average pore size of the microporous film in the anode side is D, the ratio of the average pore size C to D is preferably located within a range of 0.1 or larger and 0.83 or smaller.

As described above, the average pore size of all the separator is not simply reduced, and the average pore size of the microporous film in the cathode side is relatively different from the average pore size of the microporous film in the anode side to prevent an internal short-circuit resulting from the entry of the active materials falling from the anode and the cathode to the pores and to smoothly move ions in the separator. Further, when the average pore size of the microporous film in the cathode side is relatively large, a nonaqueous electrolyte can be more held than that in the anode side. Accordingly, the nonaqueous electrolyte is sufficiently supplied to the cathode whose conductivity is ordinarily inferior so that an ionic conductivity in the cathode can be ensured.

Further, since the anode including the material capable of being doped with and dedoped from lithium terribly expands and shrinks upon charging and discharging the battery, the active materials are liable to fall. Thus, the anode inconveniently causes the internal short-circuit. However, the microporous film having the small average pore size is used in the anode side, and accordingly, the internal short-circuit resulting from the anode can be prevented.

Further, polypropylene having high strength is employed for the microporous film of the cathode side, so that the pores of the separator in the cathode side are prevented from collapsing as a result of the expansion and shrinkage of the electrode upon charging and discharging the battery. Thus, even when charging and discharging cycles are repeated, the average pore size of the cathode side is maintained, a sufficient amount of electrolyte solution can be supplied to the surface of the cathode and the ionic conductivity in the cathode can be maintained.

Other objects of the present invention and specific advantages obtained by the present invention will be more apparent from the explanation of the following embodiments.

### BRIEF DESCRIPTION OF THE DRAWINGS

FIG. 1 is a longitudinally sectional view showing one structural example of a nonaqueous electrolyte battery shown as a first embodiment, and FIG. 2 is a longitudinally sectional view showing one structural example of a nonaqueous electrolyte battery shown as a second embodiment.

### BEST MODE FOR CARRYING OUT THE INVENTION

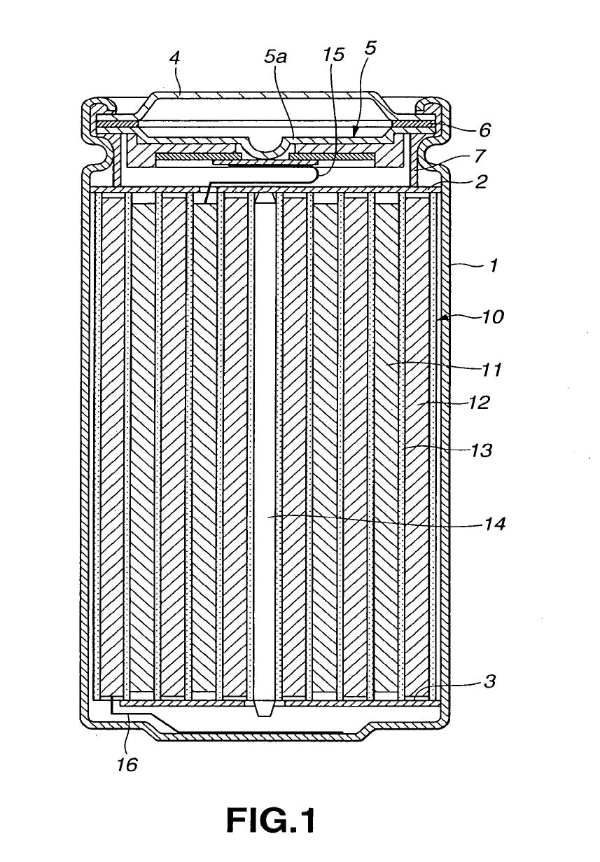

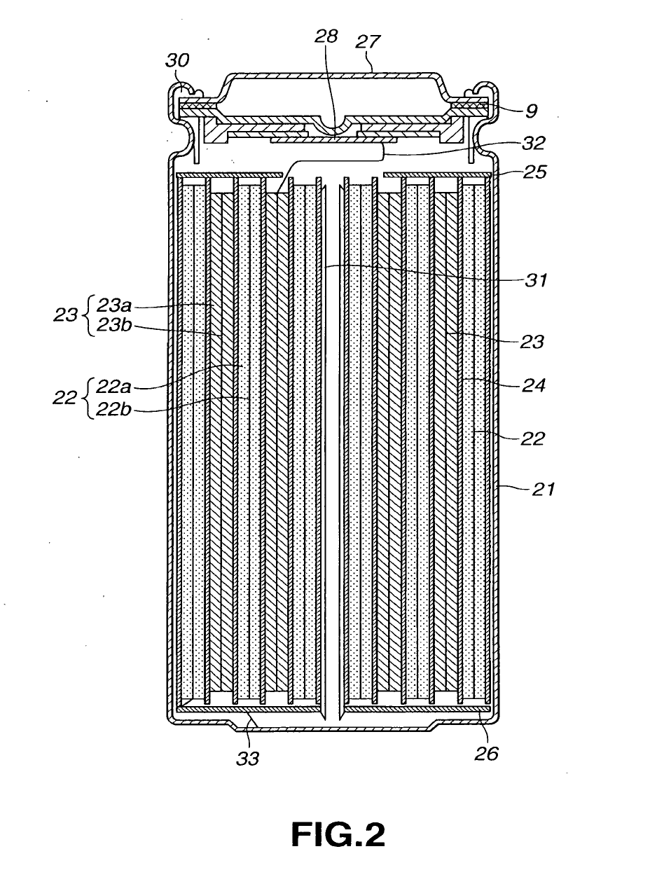

Now, a nonaqueous electrolyte battery shown as a first specific embodiment of the present invention will be described below by referring to the drawings. The nonaqueous electrolyte battery shown in FIG. 1 has a separator including a plurality of laminated microporous films made of polyolefin. Especially, there is used a separator in which the total of the layers made of porous polyethylene with a melting point lower than that of porous polypropylene is located within a range of 40% to 84% as thick as the entire thickness of the separator.

This nonaqueous electrolyte battery is what is called a cylindrical type battery and has a spirally coiled electrode body 10 formed by coiling an elongated cathode 11 and an elongated anode 12 through a separator 13 in a substantially hollow and cylindrical battery can 1. The battery can 1 is composed of, for instance, iron (Fe) plated with nickel. One end part of the battery can is closed and the other end part is opened. In the battery can 1, a pair of insulating plates 2 and 3 are respectively disposed perpendicularly to the peripheral surface of the coiled body so as to sandwich the spirally coiled electrode body 10 in between the insulating plates 2 and 3.

To the open end part of the battery can 1, a battery cover 4, and a safety valve mechanism 5 and a positive temperature coefficient element (PTC element) 6 provided inside the battery can 4 are caulked through a gasket 7 and attached. The battery can 1 is sealed. The battery cover 4 is made of, for instance, a material similar to that of the battery can 1. The safety valve mechanism 5 is electrically connected to the battery cover 4 through the positive temperature coefficient element 6. Thus, when the internal pressure of the battery reaches a prescribed value or more due to an internal short-circuit or external heating or the like, a disc plate 5a is inverted to disconnect the electric connection between the battery cover 4 and the spirally coiled electrode body 10. When temperature rises, the positive temperature coefficient element 6 serves to restrict current in accordance with the increase of a resistance value and prevent abnormal heat generation due to large current. As the positive temperature coefficient element 6, for instance, barium titanate based semiconductor ceramics is used. The gasket 7 is made of, for instance, an insulating material. Asphalt is applied to the surface of the gasket 7.

The spirally coiled electrode body 10 is coiled about, for instance, a center pin 14. A cathode lead 15 made of aluminum (Al) is connected to the cathode 11 of the spirally coiled electrode body 10. To the anode 12, an anode lead 16 made of nickel or the like is connected. The cathode lead 15 is welded to the safety valve mechanism 5 so that it is electrically connected to the battery cover 4. The anode lead 16 is welded and electrically connected to the battery can 1.

The cathode 11 comprises, for instance, a cathode composite mixture layer and a cathode current collector layer and has a structure that the cathode composite mixture layer is provided on both the surfaces or one surface of the cathode current collector layer. The cathode current collector layer is made of a metallic foil such as an aluminum foil, a nickel foil or a stainless steel foil.

The cathode composite mixture layer includes a cathode active material, a binding agent and a conductive material such as graphite as required. Here, the cathode active materials are different depending on the kinds of batteries to be manufactured and are not especially limited. For instance, when a lithium battery or a lithium-ion battery is manufactured, any material capable of being doped with or dedoped from lithium may be used as the cathode active material without a special limitation. As such materials, for instance, there may be employed spinel lithium manganese metal oxides expressed by Li(Mn_{2-x-y}LiM_{y})O₄ (in the formula, M designates at least one kind of element selected from a group including B, Mg, Ca, Sr, Ba, Ti, V, Cr, Mn, Fe, Co, Ni, Cu, Al, Sn, Sb, In, Nb, Mo, W, Y, Ru and Rh. Further, x is represented by the expression of 0≦x≦1, and y is represented by the expression of 0≦y≦0.4), composite oxides composed of lithium and transition metals expressed by a general formula LiMO₂ (in the formula, M designates at least one or more kinds of elements selected from a group including Co, Ni, Mn, Fe, Al, V, and Ti.), intercalation compounds including Li, etc. As the specific examples of lithium composite oxides, there may be exemplified LiCoO₂, LiNiO₂, LiN_{z}Co_{1-z}O₂ (in the formula, z is expressed by 0<z<1), LiMn₂O₄, etc. These lithium composite oxides can generate high voltage so that they become the cathode active materials excellent in energy density. For the cathode, a plurality of kinds of materials of these cathode active materials may be combined together and used. In addition, when the above described cathode active materials are employed to form the cathode, a well-known conductive agent or a binding agent may be added thereto.

The anode 12 has, similarly to the cathode 11, a structure that an anode composite mixture layer is provided respectively on both the surfaces or one surface of an anode current collector layer. The anode current collector layer is made of, for instance, a metallic foil such as a copper foil, a nickel foil or a stainless steel foil. The anode composite mixture layer includes any one or two or more kinds of anode materials between lithium metal, lithium alloy such as LiAl, or materials capable of being doped with or dedoped from lithium under a potential of, for instance, 2 V or lower by considering the potential of lithium metal to a reference, and further the binding agent such as polyvinylidene fluoride as necessary.

As the anode materials capable of being doped with or dedoped from lithium, there may be exemplified carbon materials, metallic oxides, polymer materials, etc. As the carbon materials, there are enumerated, for instance, non-graphitizable carbon, artificial graphite, natural graphite, coke, graphites, vitreous carbons, organic polymer compound sintered body, carbon fibers, activated carbon, carbon black, etc. The coke includes pitch coke, needle coke, petroleum coke, etc. The organic polymer compound sintered body is obtained by sintering a polymer material such as a phenolic resin or a furan resin at suitable temperature and carbonizing it. As the metallic oxides, there may be exemplified oxides capable of being doped with or dedoped from lithium under a relatively low potential such as iron oxide, ruthenium oxide, molybdenum oxide, tungsten oxide, tin oxide etc. Besides, nitrides may be likewise used.

As the polymer materials, there are exemplified conductive polymer materials such as polyacetylene, poly-p-phenylene, etc. Further, metals capable of forming alloys with lithium and alloys thereof may be used.

The separator 13 has a structure that three or more layers made of polyolefin are laminated. Especially, the outermost layer is made of porous polypropylene and at least one layer of inner layers sandwiched in between the porous polypropylene layers is made of porous polyethylene. The total of the thickness of the layers made of porous polyethylene is characteristically located within a range of 40% to 84% as thick as the entire thickness of the separator.

In the above-described construction, the total of the thickness of the layers made of porous polyethylene whose melting point is lower than that of porous polypropylene is located within a range of 40% to 84% as thick as the entire thickness of the separator, so that the separator has a satisfactory strength, and even when the internal temperature of the battery rises due to an external short-circuit or the like, the heat in the battery can be absorbed to suppress a chemical reaction in the battery. Thus, the internal temperature of the battery can be assuredly lowered.

When the total of the thickness of the layers made of porous polyethylene is lower than 40% as thick as the entire thickness of the separator, the amount of porous polyethylene is small, and accordingly, temperature at which the current in the battery is cut off, that is, shut-down temperature rises. When the shut-down temperature is near the melting point of lithium, there is a fear that lithium in a battery element may possibly generate heat. When lithium generates heat, the heat absorption by the separator cannot come up with the heat generation of lithium. Thus, the temperature of the battery cannot be controlled and the chemical reaction in the battery cannot be completely suppressed.

Further, when the total of the thickness of the layers made of porous polyethylene is higher than 84% as thick as the entire thickness of the separator, since the ratio of porous polyethylene is excessively large, a melt-down phenomenon is apt to be generated and the piercing strength of the separator is damped. Accordingly, a short-circuit is apt to be generated and the yield and reliability of the battery are lowered.

Therefore, the total of the thickness of the layers made of porous polyethylene is located within a range of 40% to 84% as thick as the entire thickness of the separator, so that the temperature of the battery can be assuredly controlled and the chemical reaction in the battery can be suppressed. Thus, the nonaqueous electrolyte battery with high reliability can be realized.

Further, the thickness of the separator is preferably located within a range of 15 μm to 40 μm, further preferably, within a range of 20 μm to 30 μm. When the thickness of the separator is smaller than 15 μm, a yield upon producing the separator is lowered. When the thickness of the separator is larger than 40 μm, the occupied volume of the separator in the battery is increased and the occupied volume of the electrodes is reduced by the above volume, hence the capacity of the battery is caused to be lowered. Further, there is a fear that the electric resistance of the separator may be possibly increased.

The porosity of the separator is preferably located within a range of 30% to 50%, and further preferably located within a range of 35% to 45%. In this case, the porosity means the rate of pore volume included in the porous material relative to the entire volume of the porous material. When the porosity is lower than 30%, the electric resistance of the separator may be probably increased. When the porosity is higher than 50%, the yield when the separator is produced may be possibly lowered.

In this separator, the thickness of the outermost layer made of porous polypropylene is preferably 2 μm or more. When the thickness of the outermost layer made of porous polypropylene is smaller than 2 μm, a yield upon producing the separator is lowered.

Further, the melting point of porous polyethylene used for the separator is preferably located within a range of 130° C. to 135° C. When the melting point of the porous polyethylene is set to a range of 130° C. to 135° C., the above-described effects can be assuredly obtained. When the melting point of the porous polyethylene is lower than 130° C., the yield upon producing the separator is lowered. Further, when the melting point of the porous polyethylene is higher than 135° C., effective shut-down characteristics cannot be obtained.

The separator made of polyolefin is liable to receive the influence of heat due to a friction. That is, the separator made of polyolefin is liable to undergo thermal influences such as frictional heat on the electrodes upon coiling the battery element when the battery is produced or frictional heat upon inserting the battery element into the battery can.

Specifically, the separator made of polyolefin generates a heat shrinkage due to the frictional heat. When the heat shrinkage of the separator is large, the cathode may come into physical contact with the anode to generate a short-circuit.

Thus, in the separator made of polyolefin, a heat shrinkability of the separator is preferably set to 10% or lower. The heat shrinkability of the separator is preset to 10% or lower, so that even when the frictional heat with the electrodes upon coiling the battery element in producing the battery or the frictional heat upon inserting the battery element into the battery can is applied to the separator, the separator does not heat-shrink to a prescribed amount or more. Accordingly, the short-circuit due to the physical contact between the cathode and the anode can be prevented. In other words, the heat shrinkability of the separator is set to 10% or lower so that the nonaqueous electrolyte battery in which the percent defective of the battery, that is, the ratio of generation of short-circuit is reduced and the reliability is high can be realized.

In order to obtain the heat shrinkability of the separator of 10% or lower, the melting point of the porous polyethylene used for the separator is preferably located within a range of 120° C. to 135° C. The melting point of the porous polyethylene used for the separator is located within a range of 120° C. to 135° C., so that the heat shrinkability can be assuredly set to 10% or lower. In other words, the above-described effects can be certainly achieved. When the melting point of the porous polyethylene is lower than 120° C., the percentage defective upon production is increased. Further, when the melting point of the porous polyethylene is higher than 135° C., there arises a fear that the effective shut-down effect may not be possibly obtained.

At this time, the average particle size of the cathode active materials is preferably located within a range of 3 μm to 30 μm. When the average particle size of the cathode active materials is smaller than 3 μm, the cathode active materials may enter the pores of the separator to come into contact with an anode electrode and generate a short-circuit. When the average particle size of the cathode active materials is larger than 30 μm, a load capacity maintaining/retention ratio is deteriorated. Further, the average particle size of the cathode active material is preferably located within a range of 5 μm to 20 μm.

For obtaining the heat shrinkability of the separator of 10% or lower, the 90% cumulative pore size of the separator is set to a range of 0.02 μm to 2 μm. The 90% cumulative pore size of the separator is set to a range of 0.02 μm to 2 μm so that the heat shrinkability of the separator can be assuredly determined to be 10% or lower. In other words, the above-described effects can be assuredly obtained. More preferably, the 90% cumulative pore size is located within a range of 0.04 μm to 1 μm.

At this time, the average particle size of the cathode active materials is preferably located within a range of 3 μm to 30 μm. When the average particle size of the cathode active materials is smaller than 3 μm, the cathode active materials may enter the pores of the separator to come into contact with the anode electrode and generate a short-circuit. When the average particle size of the cathode active materials is larger than 30 μm, a load capacity maintaining/retention ratio may be probably deteriorated. Further, the average particle size of the cathode active materials is preferably located within a range of 5 μm to 20 μm.

The separator 13 is impregnated with nonaqueous electrolyte solution as liquid nonaqueous electrolyte. The nonaqueous electrolyte solution is obtained by dissolving, for instance, lithium salt as electrolyte salt in a nonaqueous solvent. As the nonaqueous solvents, there are exemplified, for example, propylene carbonate, ethylene carbonate, diethyl carbonate, dimethyl carbonate, methyl ethyl carbonate, 1, 2-dimethoxyethane, 1, 2-diethoxyethane, g-butyrolactone, tetrahydrofuran, 2-methyl tetrahydrofuran, 1, 3-dioxolane, 4-methyl-1, 3-dioxolane, diethyl ether, sulfolane, methyl sulfolane, acetonitrile, propionitrile, anisole, acetate such as methyl acetate or ethyl acetate, butyrate or propionate, methyl formate, ethyl formate, etc., and there may be preferably mixed and used any one or two or more kinds of them.

As lithium salts, there are exemplified, for example, LiClO₄, LiAsF₆, LiPF₆, LiBF₄, LiB(C₆H₅), LiN(CF₃SO₂)₂, LiCH₃SO₃, LiCF₃SO₃, LiCl, LiBr, etc. and there may be mixed and used any one or two or more kinds of them.

The nonaqueous electrolyte battery constructed as mentioned above operates in the following manner.

When the nonaqueous electrolyte battery is charged, for instance, lithium ions are doped from the cathode 11 and dedoped to the anode 12 through the electrolyte with which the separator 13 is impregnated. When the nonaqueous electrolyte battery is discharged, for instance, the lithium ions are dedoped from the anode 12 and doped to the cathode 11 through the electrolyte with which the separator 13 is impregnated.

The nonaqueous electrolyte battery can be manufactured in such a manner as described below. Initially, for instance, manganese-containing oxide is mixed with nickel-containing oxide, and further mixed with a conductive agent and a binding agent as necessary to prepare a cathode composite mixture. This cathode composite mixture is dispersed in a solvent such as N-methyl-2-pyrrolidone to have paste type cathode composite mixture slurry. The cathode composite mixture slurry is applied to the cathode current collector layer to dry the solvent, then, the cathode composite mixture is compression-molded by a roller press machine or the like to form the cathode composite mixture layer, and the cathode 11 is thus manufactured.

Then, for instance, the anode material is mixed with a binding agent, as required to prepare an anode composite mixture. This anode composite mixture is dispersed in a solvent such as N-methyl-2-pyrrolidone to have paste type anode composite mixture slurry. The anode composite mixture slurry is applied to the anode current collector layer to dry the solvent. Then, the anode composite mixture is compression-molded by a roller press machine or the like to form the anode composite mixture layer and thus manufacture the anode 12.

Subsequently, the cathode lead 15 is attached to the cathode current collector layer by welding or the like. Similarly, the anode lead 16 is attached to the anode current collector layer. After that, the cathode 11 and the anode 12 are coiled through the separator 13. The end part of the cathode lead 15 is welded to the safety valve mechanism 5 and the end part of the anode lead 16 is welded to the battery can 1. The coiled cathode 11 and the anode 12 are sandwiched in between a pair of insulating plates 2 and 3 and accommodated in the battery can 1.

As the separator, a separator having a structure that three or more layers made of polyolefin are laminated is used. In the separator, the outermost layer is made of porous polypropylene, at least one layer of the inner layers sandwiched in between the outermost layers made of porous polypropylene is made of porous polyethylene and the total of the thickness of the layers made of polyethylene is located within a range of 40% to 84% as thick as the entire thickness of the separator.

Then, after the cathode 11 and the anode 12 are accommodated in the battery can 1, the nonaqueous electrolyte solution is injected into the battery can 1 and the separator 13 is impregnated therewith. After that, the battery cover 4, the safety valve mechanism 5 and the positive temperature coefficient element 6 are fixed to the opening end part of the battery can 1 by caulking them. Thus, the nonaqueous electrolyte battery 1 shown in FIG. 1 is formed.

In the above description, methods for manufacturing the cathode and the anode are not especially limited. That is, there may be employed various kinds of methods such as a method for adding a well-known binding agent or the like to the active material, adding a solvent thereto and applying the obtained material to current collectors, a method for adding a well-known binding agent or the like to the active material, heating the obtained material and applying it to current collectors, a method for using the active material alone or a conductive material, further mixing it with a binding agent and molding the obtained mixture to form a compact electrode, etc. Otherwise, while the active material is heated, the active material may be pressed and molded irrespective of the presence or absence of the binding agent to manufacture an electrode having high strength.

In the above description, although the cathode and the anode are coiled through the separator, there may be utilized a method for coiling the cathode and the anode through the separator disposed therebetween about a core, a method for sequentially laminating electrodes and separators, etc.

Although the present invention is described by way of the specific embodiment, the present invention is not limited thereto and the present invention may be properly changed within a scope without departing from the gist of the present invention.

In the specification, although one embodiment of the cylindrical type nonaqueous electrolyte battery having the coil structure is described above, the present invention may be applied to cylindrical type nonaqueous electrolyte batteries having other structures. Further, the form of the battery is not limited to the cylindrical form and the present invention may be similarly applied to nonaqueous electrolyte batteries having various kinds of forms except the cylindrical type such as a coin type, a button type, a prismatic type or a type in which an electrode element is sealed in a laminate film, etc.

Further, although an example in which the nonaqueous electrolyte solution obtained by dissolving the electrolyte salt as a nonaqueous electrolyte in the nonaqueous solvent is used is described, the present invention is not limited thereto, and may be used any of a solid electrolyte including an electrolyte and a gel electrolyte impregnated with the nonaqueous electrolyte solution produced by dissolving the electrolyte salt in the nonaqueous solvent. As the solid electrolyte, may be used any of an inorganic solid electrolyte or a solid polymer electrolyte which is a material having a lithium ionic conductivity.

As the inorganic solid electrolyte, there may be exemplified, for instance, lithium nitride, lithium iodide, etc. The solid polymer electrolyte comprises an electrolyte salt and a polymer compound for dissolving it. As the polymer compounds, there may be used, for instance, poly (ethylene oxide), or ether polymers such as bridged materials thereof, poly (methacrylate) esters, acrylate may be independently used or copolymerized or mixed in molecules to be used.

As gel electrolytes, there may be used lithium salts, for example, LiClO₄, LiAsF₆, LiPF₆, LiBF₄, LiB(C₆H₅), LiN(CF₃SO₂)₂, LiCH₃SO₃, LiCF₃SO₃, LiCl, LiBr, etc. and there may be mixed and used any one or two or more kinds of them. As the amount of addition of electrolyte salt, the concentration of the gel electrolyte in the nonaqueous electrolyte solution is preferably located within a range of 0.8 to 2.0 mol/l to obtain an excellent ionic conductivity.

Further, as the nonaqueous solvents used for the gel electrolyte, there may be used independently or mixed and used two or more kinds of materials, for example, ethylene carbonate, propylene carbonate, butylene carbonate, g-butyrolactone, diethoxyethane, tetrahydrofuran, 2-methyl tetrahydrofuran, 1, 3-dioxolane, methyl acetate, methyl propionate, dimethyl carbonate, diethyl carbonate, methyl ethyl carbonate, 2, 4-difluoro anisole, 2, 6-difluoro anisole, 4-bromoveratrole, etc.

As polymer materials used for the gel electrolyte, there may be various kinds of polymers which absorbs nonaqueous electrolyte solution to gel. As such polymer materials, there may be employed, polyvinylidene fluoride, copolymers of polyvinylidene fluoride, or fluorinated polymers such as poly(vinylidene fluoride), poly(vinylidene fluoride-co-hexafluoro propylene), etc.

As monomers to be copolymerized in the copolymers of polyvinylidene fluoride, there can be used, for instance, hexafluoro propylene, tetrafluoro ethylene, etc. Then, when polyvinylidene fluoride is employed as the gel electrolyte, there may be preferably used a gel electrolyte composed of polyphyletic polymer which is copolymerized with polyhexafluoro propylene, polytetrafluoroethylene, etc. Such polyphyletic polymers are used so that a gel electrolyte with high mechanical strength can be obtained.

Further, a polyphyletic polymer copolymerized with polyvinylidene fluoride and polyhexafluoro propylene is more preferably employed. Such a polyphyletic polymer is used so that a gel electrolyte of higher mechanical strength can be got.

In addition, as the polymer materials used for the gel electrolyte, there may be employed ether polymers such as polyethylene oxide or copolymers of polyethylene oxide, etc. Here, as monomers to be copolymerized in the copolymers of polyethylene oxide, there may be used, for instance, polypropylene oxide, methyl methacrylate, butyl methacrylate, methyl acrylate, butyl acrylate, etc.

Still further, as the polymer materials used for the gel electrolyte, there may be used polyacrylonitrile or copolymers of polyacrylonitrile. As monomers to be copolymerized in the copolymers of polyacrylonitrile, there may be used, for instance, vinyl acetate, methyl methacrylate, butyl methacrylate, methyl acrylate, butyl acrylate, itaconic acid, hydrogenated methyl acrylate, hydrogenated ethyl acrylate, acryl amide, vinyl chloride, vinylidene fluoride, vinylidene chloride, etc. Further, there may be used acrylonitrile butadiene rubber, acrylonitrile butadiene styrene resin, acrylonitrile chlorinated polyethylene propylenediene styrene resin, acrylonitrile vinyl chloride resin, acrylonitrile methyl acrylate resin, acrylonitrile acrylate resin, etc. Especially, fluorinated polymers are preferably used among the above described compounds from the viewpoint of oxidation-reduction stability.

### Example 1

Now, the present invention will be described on the basis of specific experimental results.

The porosity and the 90% cumulative pore size of a separator in the following experiments were measured by a mercury porosimeter poremaster 33P (produced by Yuasa Ionic Co., Ltd.) and obtained from a pore distribution curve got from the amount of mercury and pressure relative to the size of pores. The melting point of microporous polyethylene used for the separator was obtained from temperature at which a heat absorption reached a maximum value by carrying out a differential scanning calorimetry (DSC) in accordance with JIS-K-7121 except that temperature rise speed was 5° C./min.

### [Experiment 1]

In an Experiment 1, the rate of microporous polyethylene relative to the thickness of a separator and the melting point of the microporous polyethylene were examined.

### [Sample 1]

In a Sample 1, a nonaqueous electrolyte battery was manufactured as described below.

A cathode was manufactured as described below. Initially, lithium cobalt oxide of 85 parts by weight having a composition of LiCoO₂, a conductive agent of 10 parts by weight and a binding agent of 5 parts by weight were mixed together to prepare a cathode composite mixture. In this case, as the conductive agent, graphite was used and polyvinylidene fluoride (PVDF) was used as the binding agent.

Then, the cathode composite mixture was dispersed in N-methylpyrrolidone as a solvent to have slurry. Then, the slurry was uniformly applied to both the surfaces of an elongated aluminum foil having the thickness of 20 μm as a cathode current collector and dried to form a cathode active material layers. After that, the cathode active material layers were compression-molded under prescribed pressure by using a roll press machine so that a cathode was manufactured.

Subsequently, an anode was manufactured as described below. Initially, a non-graphitizable carbon material of 90 parts by weight and a binding agent of 10 parts by weight were mixed together to prepare an anode composite mixture. In this case, PVDF was used as the binding agent.

Then, the anode composite mixture was dispersed in N-methylpyrrolidone as a solvent to have slurry. Then, the slurry was uniformly applied to both the surfaces of an elongated copper foil having the thickness of 15 μm as an anode current collector and dried to form anode active material layers. After that, the anode active material layers were compression-molded under prescribed pressure by using the roll press machine so that an anode was manufactured.

The cathode and the anode obtained in this manner and the separator were coiled many times while they were stacked the anode, the separator, the cathode and the separator respectively to manufacture a spirally coiled electrode body having the outside diameter of 18 mm.

Here, as the separator, a polyolefin separator made of three layers of microporous polypropylene (PP, thickness of 7 μm)-microporous polyethylene (PE, thickness of 13 μm)-microporous polypropylene (PP, thickness of 7 μm) and having the thickness of 27 μm was used. Here, the microporous polyethylene whose melting point was 135° C. was employed.

Then, an insulating plate was inserted on the bottom part of a battery can made of iron the inside of which was plated with nickel, further, the spirally coiled electrode body was accommodated therein and an insulating plate was mounted on the spirally coiled electrode body.

Then, in order to collect electric current of the anode, one end of an anode lead made of nickel was attached to the anode under pressure and the other end was welded to the battery can. Further, in order to collect an electric current of the cathode, one end of a cathode lead made of aluminum was attached to the cathode and the other end was electrically connected to a battery cover through a current cutting-off plate. This current cutting-off plate serves to cut off current in accordance with the internal pressure of a battery.

Subsequently, nonaqueous electrolyte solution was injected into the battery can. The nonaqueous electrolyte solution was prepared by dissolving LiPF₆ in the mixed solvent including propylene carbonate and dimethyl carbonate of equal volume at the rate of 1 mol/liter and used.

Finally, the battery can was caulked through an insulating sealing gasket to which asphalt was applied to fix a safety valve mechanism having a current cutting-off mechanism, a PTC element and the battery cover to the battery can so that the air-tightness of the battery was maintained and a cylindrical type nonaqueous electrolyte battery having the diameter of 18 mm and the height of 65 mm was manufactured.

### [Sample 2]

In a Sample 2, a cylindrical type nonaqueous electrolyte battery was manufactured in the same manner as that of the Sample 1 except that as the separator, a polyolefin separator made of three layers of microporous polypropylene (PP, thickness of 5 μm)-microporous polyethylene (PE, thickness of 15 μm)-microporous polypropylene (PP, thickness of 5 μm) and having the thickness of 25 μm was used. Here, the microporous polyethylene whose melting point was 133° C. was employed.

### [Sample 3]

In a Sample 3, a cylindrical type nonaqueous electrolyte battery was manufactured in the same manner as that of the Sample 1 except that as the separator, a polyolefin separator made of three layers of microporous polypropylene (PP, thickness of 5 μm)-microporous polyethylene (PE, thickness of 15 μm)-microporous polypropylene (PP, thickness of 5 μm) and having the thickness of 25 μm was used. Here, the microporous polyethylene whose melting point was 130° C. was employed.

### [Sample 4]

In a Sample 4, a cylindrical type nonaqueous electrolyte battery was manufactured in the same manner as that of the Sample 1 except that as the separator, a polyolefin separator made of three layers of microporous polypropylene (PP, thickness of 7 μm)-microporous polyethylene (PE, thickness of 11 μm)-microporous polypropylene (PP, thickness of 7 μm) and having the thickness of 25 μm was used. Here, the microporous polyethylene whose melting point was 130° C. was employed.

### [Sample 5]

In a Sample 5, a cylindrical type nonaqueous electrolyte battery was manufactured in the same manner as that of the Sample 1 except that as the separator, a polyolefin separator made of three layers of microporous polypropylene (PP, thickness of 7.5 μm)-microporous polyethylene (PE, thickness of 10 μm)-microporous polypropylene (PP, thickness of 7.5 μm) and having the thickness of 25 μm was used. Here, the microporous polyethylene whose melting point was 130° C. was employed.

### [Sample 6]

In a Sample 6, a cylindrical type nonaqueous electrolyte battery was manufactured in the same manner as that of the Sample 1 except that as the separator, a polyolefin separator made of three layers of microporous polypropylene (PP, thickness of 2 μm)-microporous polyethylene (PE, thickness of 21 μm)-microporous polypropylene (PP, thickness of 2 μm) and having the thickness of 25 μm was used. Here, the microporous polyethylene whose melting point was 130° C. was employed.

### [Sample 7]

In a Sample 7, a cylindrical type nonaqueous electrolyte battery was manufactured in the same manner as that of the Sample 1 except that as the separator, a polyolefin separator made of three layers of microporous polypropylene (PP, thickness of 7 μm)-microporous polyethylene (PE, thickness of 11 μm)-microporous polypropylene (PP, thickness of 7 μm) and having the thickness of 25 μm was used. Here, the microporous polyethylene whose melting point was 125° C. was employed.

### [Sample 8]

In a Sample 8, a cylindrical type nonaqueous electrolyte battery was manufactured in the same manner as that of the Sample 1 except that as the separator, a polyolefin separator made of three layers of microporous polypropylene (PP, thickness of 7 μm)-microporous polyethylene (PE, thickness of 11 μm)-microporous polypropylene (PP, thickness of 7 μm) and having the thickness of 25 μm was used. Here, the microporous polyethylene whose melting point was 140° C. was employed.

### [Sample 9]

In a Sample 9, a cylindrical type nonaqueous electrolyte battery was manufactured in the same manner as that of the Sample 1 except that as the separator, a polyolefin separator made of three layers of microporous polypropylene (PP, thickness of 9 μm)-microporous polyethylene (PE, thickness of 7 μm)-microporous polypropylene (PP, thickness of 9 μm) and having the thickness of 25 μm was used. Here, the microporous polyethylene whose melting point was 133° C. was employed.

### [Sample 10]

In a Sample 10, a cylindrical type nonaqueous electrolyte battery was manufactured in the same manner as that of the Sample 1 except that as the separator, a polyolefin separator made of only a microporous polyethylene layer (PE, thickness of 25 μm) and having the thickness of 25 μm was used. Here, the microporous polyethylene whose melting point was 125° C. was employed.

### [Sample 11]

In a Sample 11, a cylindrical type nonaqueous electrolyte battery was manufactured in the same manner as that of the Sample 1 except that as the separator, a polyolefin separator made of only a microporous polypropylene (PP, thickness of 25 μm) layer and having the thickness of 25 μm was used.

### [Sample 12]

In a Sample 12, a cylindrical type nonaqueous electrolyte battery was manufactured in the same manner as that of the Sample 1 except that as the separator, a polyolefin separator made of three layers of microporous polypropylene (PP, thickness of 1 μm)-microporous polyethylene (PE, thickness of 23 μm)-microporous polypropylene (PP, thickness of 1 μm) and having the thickness of 25 μm was used. Here, the microporous polyethylene whose melting point was 130° C. was employed.

### External Short-Circuit Test

An external short-circuit test was carried out by connecting the cathode terminal of the cylindrical type nonaqueous electrolyte battery to an anode terminal through shunt resistance of 0.5 mW and a conductor to generate an external short-circuit and to examine whether or not the short-circuit, that is, the internal short-circuit of the cylindrical type nonaqueous electrolyte battery was generated. A short-circuit factor was represented by the ratio (the number of short-circuits/the total number of batteries) the number of short-circuited batteries to the total number (100) of batteries for which the external short-circuit test was carried out. At this time, maximum attainable temperature in the batteries and the resistance values of the separators in the batteries were measured. The results thus obtained are shown in Table 1.

TABLE 1

| | | Thickness of Each | | | PE |
|---|---|---|---|---|---|
| | Thickness of | Layer of Separator | | | Rate of |
| | Separator | PP | PE | PP | Thickness |
| | (μm) | (μm) | (μm) | (μm) | (%) |
| Sample 1 | 27 | 7 | 13 | 7 | 48.1 |
| Sample 2 | 25 | 5 | 15 | 5 | 60 |
| Sample 3 | 25 | 5 | 15 | 5 | 60 |
| Sample 4 | 25 | 7 | 11 | 7 | 44 |
| Sample 5 | 25 | 7.5 | 10 | 7.5 | 40 |
| Sample 6 | 25 | 2 | 21 | 2 | 84 |
| Sample 7 | 25 | 7 | 11 | 7 | 44 |
| Sample 8 | 25 | 7 | 11 | 7 | 44 |
| Sample 9 | 25 | 9 | 7 | 9 | 28 |
| Sample 10 | 25 | 0 | 25 | 0 | 100 |
| Sample 11 | 25 | 25 | 0 | 0 | 0 |
| Sample 12 | 25 | 1 | 23 | 1 | 92 |

| | | | Short-circuit | | |
|---|---|---|---|---|---|
| | | | Factor | | |
| | | | (Number | Maximum | |
| | PE | | of Short- | Attainable | Resistance |
| | Melting | | circuits/total | Temperature | Value in |
| | Point | Porosity | Number of | in Battery | Battery |
| | (° C.) | (%) | Batteries) | (° C.) | (mW) |
| Sample 1 | 135 | 42 | 0/100 | 99 | 60 |
| Sample 2 | 133 | 42 | 0/100 | 98 | 60 |
| Sample 3 | 130 | 42 | 0/100 | 96 | 60 |
| Sample 4 | 130 | 42 | 0/100 | 95 | 61 |
| Sample 5 | 130 | 42 | 0/100 | 95 | 59 |
| Sample 6 | 130 | 42 | 3/100 | 93 | 60 |
| Sample 7 | 125 | 42 | 10/100 | 101 | 60 |
| Sample 8 | 140 | 42 | 0/100 | 111 | 60 |
| Sample 9 | 133 | 42 | 0/100 | 109 | 60 |
| Sample 10 | 125 | 42 | 34/100 | 90 | 59 |
| Sample 11 | — | 42 | 0/100 | 120 | 59 |
| Sample 12 | 130 | 42 | 29/100 | 92 | 60 |

As apparent from the Table 1, each of the Sample 1 to the Sample 8 using the separator made of three layers of microporous polypropylene-microporous polyethylene-microporous polypropylene and having the thickness of microporous polyethylene located within a range of 40% to 84% as thick as the thickness of the separator has good values sufficient to be practically used in view of the short-circuit factor, the maximum attainable temperature in a battery and the resistance value in a battery.

On the other hand, it is recognized that the Sample 9 and the Sample 11 using the separators having the thickness of the microporous polyethylene located within ranges of 28% and 0% as thick as the thickness of the separators, that is, using the separators made of only the microporous polypropylene have good values with respect to the short-circuit factor and the resistance value in a battery, however cannot have good values with respect to the maximum attainable temperature in a battery.

Further, it is understood that the Sample 12 and the Sample 10 using the separators having the thickness of the microporous polyethylene located within ranges of 92% and 100% as thick as the thickness of the separators, that is, using the separators made of only the microporous polyethylene have good values in view of the maximum attainable temperature in a battery and the resistance value in a battery, however, cannot have good values with respect to the short-circuit factor.

As apparent from the above description, the polyolefin separator including the three layers of microporous polypropylene-microporous polyethylene-microporous polypropylene and having the thickness of the microporous polyethylene located within a range of 40% to 84% as thick as the thickness of the separator is used so that the cylindrical type nonaqueous electrolyte battery, can be realized, which is excellent in its short-circuit factor, maximum attainable temperature in a battery and resistance value in a battery.

Especially, the Sample 1 to the Sample 6 in the Sample 1 to the Sample 8 having the melting point of the microporous polyethylene located within a range of 130° C. to 135° C. have good results. On the other hand, it is understood that the Sample 7 in which the melting point of the microporous polyethylene is 125° C. has good values in view of the maximum attainable temperature and the resistance value in a battery, however is rather inferior in view of the short-circuit factor.

Further, it is understood that the Sample 8 in which the melting point of the microporous polyethylene is 140° C. has good values in view of the short-circuit factor and the resistance value in a battery, however is rather inferior in its maximum attainable temperature in a battery.

As recognized from the above description, when the thickness of the microporous polyethylene is located within a range of 40% to 84% as thick as the thickness of the separator, the melting point of the microporous polyethylene is located within a range of 130° C. to 135° C., so that the cylindrical type nonaqueous electrolyte battery excellent from all the viewpoints of short-circuit factor, maximum attainable temperature in a battery and resistance value in a battery can be more assuredly realized.

Further, the thickness of the outermost layer made of microporous polypropylene was set to 2 μm or larger, so that the separator could be manufactured with good yield.

### [Experiment 2]

In an Experiment 2, the thickness of the separator was examined.

### [Sample 13]

In a Sample 13, a cylindrical type nonaqueous electrolyte battery was manufactured in the same manner as that of the Sample 1 except that as the separator, a polyolefin separator made of three layers of microporous polypropylene (PP, thickness of 2 μm)-microporous polyethylene (PE, thickness of 6 μm)-microporous polypropylene (PP, thickness of 2 μm) and having the thickness of 10 μm was used. Here, the microporous polyethylene whose melting point was 131° C. was employed.

### [Sample 14]

In a Sample 14, a cylindrical type nonaqueous electrolyte battery was manufactured in the same manner as that of the Sample 13 except that as the separator, a polyolefin separator made of three layers of microporous polypropylene (PP, thickness of 3.5 μm)-microporous polyethylene (PE, thickness of 8 μm)-microporous polypropylene (PP, thickness of 3.5 μm) and having the thickness of 15 μm was used.

### [Sample 15]

In a Sample 15, a cylindrical type nonaqueous electrolyte battery was manufactured in the same manner as that of the Sample 13 except that as the separator, a polyolefin separator made of three layers of microporous polypropylene (PP, thickness of 4 μm)-microporous polyethylene (PE, thickness of 12 μm)-microporous polypropylene (PP, thickness of 4 μm) and having the thickness of 20 μm was used.

### [Sample 16]

In a Sample 16, a cylindrical type nonaqueous electrolyte battery was manufactured in the same manner as that of the Sample 13 except that as the separator, a polyolefin separator made of three layers of microporous polypropylene (PP, thickness of 7 μm)-microporous polyethylene (PE, thickness of 16 μm)-microporous polypropylene (PP, thickness of 7 μm) and having the thickness of 30 μm was used.

### [Sample 17]

In a Sample 17, a cylindrical type nonaqueous electrolyte battery was manufactured in the same manner as that of the Sample 13 except that as the separator, a polyolefin separator made of three layers of microporous polypropylene (PP, thickness of 10 μm)-microporous polyethylene (PE, thickness of 20 μm)-microporous polypropylene (PP, thickness of 10 μm) and having the thickness of 40 μm was used.

### [Sample 18]

In a Sample 18, a cylindrical type nonaqueous electrolyte battery was manufactured in the same manner as that of the Sample 13 except that as the separator, a polyolefin separator made of three layers of microporous polypropylene (PP, thickness of 10 μm)-microporous polyethylene (PE, thickness of 25 μm)-microporous polypropylene (PP, thickness of 10 μm) and having the thickness of 45 μm was used.

The external short-circuit test was carried out in a similar manner to the above for the cylindrical type nonaqueous electrolyte batteries of the Sample 13 to the Sample 18 manufactured as mentioned above. Results thus obtained are shown in Table 2.

TABLE 2

| | | Thickness of Each | | | PE |
|---|---|---|---|---|---|
| | Thickness of | Layer of Separator | | | Rate of |
| | Separator | PP | PE | PP | Thickness |
| | (μm) | (μm) | (μm) | (μm) | (%) |
| Sample 13 | 10 | 2 | 6 | 2 | 60 |
| Sample 14 | 15 | 3.5 | 8 | 3.5 | 53.3 |
| Sample 15 | 20 | 4 | 12 | 4 | 60 |
| Sample 16 | 30 | 7 | 16 | 7 | 53.3 |
| Sample 17 | 40 | 10 | 20 | 10 | 50 |
| Sample 18 | 45 | 10 | 25 | 10 | 55.6 |

| | | | Short-circuit | | |
|---|---|---|---|---|---|
| | | | Factor | | |
| | | | (Number | Maximum | |
| | PE | | of Short- | Attainable | Resistance |
| | Melting | | circuits/total | Temperature | Value in |
| | Point | Porosity | Number of | in Battery | Battery |
| | (° C.) | (%) | Batteries) | (° C.) | (mW) |
| Sample 13 | 131 | 42 | 6/100 | 102 | 51 |
| Sample 14 | 131 | 42 | 3/100 | 99 | 55 |
| Sample 15 | 131 | 42 | 0/100 | 98 | 57 |
| Sample 16 | 131 | 42 | 0/100 | 93 | 62 |
| Sample 17 | 131 | 42 | 0/100 | 90 | 65 |
| Sample 18 | 131 | 42 | 0/100 | 84 | 75 |

As apparent from the Table 2, each of the Sample 13 to the Sample 18 using the separator made of three layers of microporous polypropylene-microporous polyethylene-microporous polypropylene and having the thickness of microporous polyethylene located within a range of 50% to 60% as thick as the thickness of the separator has good values sufficient to be practically used in view of the short-circuit factor, the maximum attainable temperature in a battery and the resistance value in a battery. In the Sample 14 to the Sample 17 having the thickness of the separators located within a range of 15 μm to 40 μm, especially good results are obtained among them. On the other hand, it is recognized that the Sample 13 using the separator having the thickness of 10 μm has good values with respect to the maximum attainable temperature in a battery and the resistance value in a battery, however the Sample 13 is slightly inferior in view of short-circuit factor. Further, it is understood that the Sample 18 in which the thickness of the separator is 45 μm has good values in view of the maximum attainable temperature in a battery and the short-circuit factor, however the Sample 18 is rather inferior with respect to the resistance value in a battery.

As apparent from the above description, in the polyolefin separator including the three layers of microporous polypropylene-microporous polyethylene-microporous polypropylene and having the thickness of the microporous polyethylene located within a range of 40% to 84% as thick as the thickness of the separator, when the thickness of the separator is located within a range of 15 μm to 40 μm, the cylindrical type nonaqueous electrolyte battery excellent from all the viewpoints of short-circuit factor, maximum attainable temperature in a battery and resistance value in a battery can be more assuredly realized.

### [Experiment 3]

In an Experiment 3, the porosity of the separator was examined.

### [Sample 19]

In a Sample 19, a cylindrical type nonaqueous electrolyte battery was manufactured in the same manner as that of the Sample 1 except that as the separator, a polyolefin separator made of three layers of microporous polypropylene (PP, thickness of 5 μm)-microporous polyethylene (PE, thickness of 15 μm)-microporous polypropylene (PP, thickness of 5 μm) and having the thickness of 25 μm and the porosity of 20% was used. Here, the microporous polyethylene whose melting point was 131° C. was employed.

### [Sample 20]

In a Sample 20, a cylindrical type nonaqueous electrolyte battery was manufactured in the same manner as that of the Sample 19 except that the porosity of the separator was 30%.

### [Sample 21]

In a Sample 21, a cylindrical type nonaqueous electrolyte battery was manufactured in the same manner as that of the Sample 19 except that the porosity of the separator was 35%.

### [Sample 22]

In a Sample 22, a cylindrical type nonaqueous electrolyte battery was manufactured in the same manner as that of the Sample 19 except that the porosity of the separator was 45%.

### [Sample 23]

In a Sample 23, a cylindrical type nonaqueous electrolyte battery was manufactured in the same manner as that of the Sample 19 except that the porosity of the separator was 50%.

### [Sample 24]

In a Sample 24, a cylindrical type nonaqueous electrolyte battery was manufactured in the same manner as that of the Sample 19 except that the porosity of the separator was 58%.

The external short-circuit test was carried out in a similar manner to the above for the cylindrical type nonaqueous electrolyte batteries of the Sample 19 to the Sample 24 manufactured as mentioned above. Results thus obtained are shown in Table 3.

TABLE 3

| | | Thickness of Each | | | PE |
|---|---|---|---|---|---|
| | Thickness of | Layer of Separator | | | Rate of |
| | Separator | PP | PE | PP | Thickness |
| | (μm) | (μm) | (μm) | (μm) | (%) |
| Sample 19 | 25 | 10 | 15 | 5 | 60 |
| Sample 20 | 25 | 10 | 15 | 5 | 60 |
| Sample 21 | 25 | 10 | 15 | 5 | 60 |
| Sample 22 | 25 | 10 | 15 | 5 | 60 |
| Sample 23 | 25 | 10 | 15 | 5 | 60 |
| Sample 24 | 25 | 10 | 15 | 5 | 60 |

| | | | Short-circuit | | |
|---|---|---|---|---|---|
| | | | Factor | | |
| | | | (Number | Maximum | |
| | PE | | of Short- | Attainable | Resistance |
| | Melting | | circuits/total | Temperature | Value in |
| | Point | Porosity | Number of | in Battery | Battery |
| | (° C.) | (%) | Batteries) | (° C.) | (mW) |
| Sample 19 | 131 | 20 | 0/100 | 88 | 80 |
| Sample 20 | 131 | 30 | 0/100 | 92 | 65 |
| Sample 21 | 131 | 35 | 0/100 | 95 | 62 |
| Sample 22 | 131 | 45 | 0/100 | 98 | 57 |
| Sample 23 | 131 | 50 | 1/100 | 100 | 55 |
| Sample 24 | 131 | 58 | 7/100 | 105 | 55 |

As apparent from the Table 3, when the cylindrical type nonaqueous electrolyte battery was manufactured by changing the porosity of the separator within a range of 20% to 58%, the short-circuit factor, the maximum attainable temperature in a battery and the resistance value in a battery show good values sufficient to be practically used. In the Sample 20 to the Sample 23 having the porosity of the separators located within a range of 30% to 50%, especially good results are obtained among them. On the other hand, it is recognized that the Sample 19 having the porosity of the separator of 20% has good values with respect to the maximum attainable temperature in a battery and the short-circuit factor, however the Sample 19 is slightly inferior in view of the resistance value in a battery. Further, it is understood that the Sample 24 in which the porosity of the separator is 58% has good values in view of the short-circuit factor and the resistance value in a battery, however the Sample 24 is rather inferior with respect to the maximum attainable temperature in a battery.

As apparent from the above description, when the polyolefin separator including the three layers of microporous polypropylene-microporous polyethylene-microporous polypropylene and having the thickness of the microporous polyethylene of 60% as thick as the thickness of the separator is employed, the porosity of the separator is located within a range of 30% to 50%, so that the cylindrical type nonaqueous electrolyte battery excellent from all the viewpoints of short-circuit factor, maximum attainable temperature in a battery and resistance value in a battery can be more assuredly realized.

### [Experiment 4]

In an Experiment 4, a heat shrinkability of the separator was examined. The heat shrinkability of the separator was obtained as mentioned below. That is, marks were initially provided at intervals of 30 cm in the longitudinal direction (MD direction) of the separator by a felt pen for thin characters, and the separator was stored for 2 hours in a constant temperature vessel set to the temperature of 105° C. Then, the distance between the marks was measured. Then, the heat shrinkability was calculated in accordance with the following formula (1).

Heat shrinkability (%)=(30 cm−A)/30 cm [symbol] 100 (1)

A: distance after storage for 2 hours at 105° C.

### [Sample 31]

In a Sample 31, a nonaqueous electrolyte battery was manufactured as described below. Firstly, a cathode was manufactured as mentioned below. Initially, lithium carbonate of 0.5 mole was mixed with cobalt carbonate of 1 mol and this mixture was sintered in air at the temperature of 900° C. for 5 hours. An X-ray diffraction measurement was carried out for the obtained material, so that the material had a peak completely corresponding to the peak of LiCoO₂ registered in the JCPDS file.

Then, this LiCoO₂ was pulverized to have powder the average particle size of which was 15 μm. Then, LiCoO₂ powder of 95 parts by weight was mixed with lithium carbonate powder of 5 parts by weight to obtain a mixture. Further, the mixture of 91 parts by weight, a conductive agent of 6 parts by weight and a binding agent of 3 parts by weight were mixed together to prepare a cathode composite mixture. In this case, as the conductive agent, scale type graphite was used and PVDF was used as the binding agent.

Then, the cathode composite mixture was dispersed in N-methylpyrrolidone as a solvent to have slurry. Then, the slurry was uniformly applied to both the surfaces of an elongated aluminum foil having the thickness of 20 μm as a cathode current collector and dried to form cathode active material layers. After that, the cathode active material layers were compression-molded under prescribed pressure by using a roll press machine so that a cathode was manufactured.

Subsequently, an anode was manufactured as described below. Initially, coal tar pitch of 30 parts by weight as a binder was added to and mixed with coal coke of 100 parts by weight as a filler at about 100° C., and the mixture thus obtained was compression-molded by a press machine to obtain a precursor of a carbon compact. Then, the precursor was heat-treated at the temperature of 1000° C. or lower to obtain the carbon compact. Further, the carbon compact was impregnated with the coal tar pitch melted at 200° C. or lower. Heat treatment and pitch impregnation/heat treatment processes were repeated relative to the carbon compact several times under the condition of 1000° C. or lower, and then, the heat treatment was carried out in an inert atmosphere at 2800° C. to manufacture a graphitized compact. After that, the graphitized compact was pulverized and classified to have powder.

When a structural analysis for the obtained graphitized powder was carried out by an X-ray diffraction method, the interplanar spacing of (002) planes was 0.337 nm and the thickness of the C-axis crystallite of the (002) plane was 50.0 nm. True density obtained by a pycnometer method was 2.23 g/cm³ and bulk density was 0.98 g/cm³. Further, a specific surface area obtained by BET method (Brunauer-Emmett-Teller) method was 1.6 m²/g. In a particle size distribution obtained by a laser diffraction method, an average particle size was 33.0 μm, a 10% cumulative particle size was 13.3 μm, a 50% cumulative particle size was 30.6 μm and a 90% cumulative particle size was 55.7 μm. In addition, the average value of the fracture strength of the graphitized particles obtained by using the Shimadzu micro compression testing machine (produced by Shimadzu Corporation) was 7.1 kgf/mm². After the graphitized powder was obtained, the graphitized powder of 90 parts by weight was mixed with a binding agent of 10 parts by weight to prepare an anode composite mixture. Here, PVDF was used as the binding agent.

Then, the anode composite mixture was dispersed in N-methylpyrrolidone as a solvent to have slurry. Then, the slurry was uniformly applied to both the surfaces of an elongated copper foil having the thickness of 10 μm as an anode current collector and dried to form anode active material layers. After that, the anode active material layers were compression-molded under prescribed pressure by using the roll press machine so that an anode was manufactured.

The cathode and the anode obtained in this manner and the separator were coiled many times while they were stacked the anode, the separator, the cathode and the separator respectively to manufacture a spirally coiled electrode body having the outside diameter of 18 mm.

Here, as the separator, a polyolefin separator made of three layers of microporous polypropylene (PP, thickness of 5 μm)-microporous polyethylene (PE, thickness of 15 μm)-microporous polypropylene (PP, thickness of 5 μm) and having the thickness of 25 μm and the heat shrinkability of 4% was used. That is, the thickness of the microporous polyethylene is set to 60% as thick as the thickness of the separator. Here, the microporous polyethylene whose melting point was 133° C. was employed. The 90% cumulative pore size of the separator was 0.5 μm.

Then, an insulating plate was inserted on the bottom part of a battery can made of iron the inside of which was plated with nickel, further, the spirally coiled electrode body was accommodated therein and an insulating plate was further mounted on the spirally coiled electrode body.

Then, in order to collect electric current of the anode, one end of an anode lead made of nickel was attached to the anode under pressure and the other end was welded to the battery can. Further, in order to collect an electric current of the cathode, one end of a cathode lead made of aluminum was attached to the cathode and the other end was electrically connected to a battery cover through a current cutting-off plate. This current cutting-off plate serves to cut off current in accordance with the internal pressure of a battery.

Subsequently, nonaqueous electrolyte solution was injected into the battery can. The nonaqueous electrolyte solution was prepared and used by mixing LiPF₆, ethylene carbonate and dimethyl carbonate in the weight ratio 10:40:50.

Finally, the battery can was caulked through an insulating sealing gasket to which asphalt was applied to fix a safety valve mechanism having a current cutting-off mechanism, a PTC element and the battery cover to the battery can to maintain air-tightness in the battery so that the cylindrical type nonaqueous electrolyte battery having the diameter of 18 mm and the height of 65 mm was manufactured.

### [Sample 32]

In a Sample 32, a cylindrical type nonaqueous electrolyte battery was manufactured in the same manner as that of the Sample 31 except that the microporous polyethylene whose melting point was 135° C. was used and the heat shrinkability of the separator was 3% and the 90% cumulative pore size thereof was 0.6 μm.

### [Sample 33]

In a Sample 33, a cylindrical type nonaqueous electrolyte battery was manufactured in the same manner as that of the Sample 31 except that the microporous polyethylene whose melting point was 130° C. was used and the heat shrinkability of the separator was 5% and the 90% cumulative pore size thereof was 0.5 μm.

### [Sample 34]

In a Sample 34, a cylindrical type nonaqueous electrolyte battery was manufactured in the same manner as that of the Sample 31 except that the microporous polyethylene whose melting point was 125° C. was used and the heat shrinkability of the separator was 7.5% and the 90% cumulative pore size thereof was 0.4 μm.

### [Sample 35]

In a Sample 35, a cylindrical type nonaqueous electrolyte battery was manufactured in the same manner as that of the Sample 31 except that the microporous polyethylene whose melting point was 120° C. was used and the heat shrinkability of the separator was 10% and the 90% cumulative pore size thereof was 0.3 μm.

### [Sample 36]

In a Sample 36, a cylindrical type nonaqueous electrolyte battery was manufactured in the same manner as that of the Sample 31 except that the microporous polyethylene whose melting point was 117° C. was used and the heat shrinkability of the separator was 11% and the 90% cumulative pore size thereof was 0.2 μm.

The percent defective of each of the Sample 31 to the Sample 36 manufactured as described above was evaluated in the following manner. That is, a constant-current and constant-voltage charging operation was carried out for 10 hours in an atmosphere of 23° C. relative to each cylindrical type nonaqueous electrolyte battery under the conditions of upper limit voltage of 4.2 V and current of 0.3 A. After that, the battery was stored for one month under the atmosphere of 23° C., and then, an OCV measurement was carried out to determine the battery having 4.15 V or lower to be a defective article. The percent defective at this time was represented by the ratio (the number of defective articles/the total number of batteries) of the number of defective articles to the total number (50) of batteries. Further, the external short-circuit test was carried out in the same manner as described above. Further, a load capacity maintaining/retention ratio test was carried out as described below to evaluate battery characteristics.

### Load Capacity Maintaining/Retention Ratio Test

Initially, a constant-current and constant-voltage charging operation was carried out for 3 hours relative to the cylindrical type nonaqueous electrolyte batteries in a constant temperature vessel set to 23° C. under the conditions of upper limit voltage of 4.2 V and current of 1 A. Then, a constant-current discharging operation of 0.35 V was performed up to finish voltage of 3.0 V. Subsequently, a constant-current and constant-voltage charging operation was performed for 1 hour under the conditions of upper limit voltage of 4.2 V and current of 1 A, and then, a constant-current discharging operation of 3.5 A was carried out up to finish voltage of 3.0 V. Thus, the percentage of the capacity of 3.5 A to the capacity of 0.35 A was determined to be a load capacity maintaining/retention ratio.

Results thus obtained are shown in Table 4.

TABLE 4

| | | | | 90% |
|---|---|---|---|---|
| | PE | PP | Heat | Cumulative |
| | Melting Point | Melting Point | Shrinkability | Pore Size |
| | (° C.) | (° C.) | (%) | (μm) |
| Sample 31 | 133 | 165 | 4 | 0.5 |
| Sample 32 | 135 | 165 | 3 | 0.6 |
| Sample 33 | 130 | 165 | 5 | 0.5 |
| Sample 34 | 125 | 165 | 7.5 | 0.4 |
| Sample 35 | 120 | 165 | 10 | 0.3 |
| Sample 36 | 117 | 165 | 11 | 0.2 |

| | Average | | Maximum | Load Capacity |
|---|---|---|---|---|
| | Particle | | Attainable | Maintaining/ |
| | size of Cathode | | Temperature in | retention |
| | Active Material | Percent | Battery | Ratio |
| | (μm) | Defective | (° C.) | (%) |
| Sample 31 | 15 | 0/50 | 94 | 54 |
| Sample 32 | 15 | 0/50 | 98 | 53 |
| Sample 33 | 15 | 0/50 | 91 | 55 |
| Sample 34 | 15 | 0/50 | 87 | 53 |
| Sample 35 | 15 | 0/50 | 82 | 54 |
| Sample 36 | 15 | 5/50 | 87 | 52 |

As apparent from the Table 4, when the Sample 31 to Sample 36 are compared mutually, the Sample 36 in which the melting point of the microporous polyethylene is set to 117° C. and the heat shrinkability of the separator is set to 11% has percent defective higher than those of the Samples 31 to 35 in which the melting point of the microporous polyethylene is located within a range of 120° C. to 135° C. and the heat shrinkability of the separator is located within a range of 3% to 9.5%. It is difficult to consider that this occurs from a reason why, since the average particle size of the cathode active material of the Sample 36 is large as wide as 15 μm, the cathode active material enters the pores of the separator to come into contact with an anode electrode. Accordingly, it may be considered that the high percent defective of the Sample 36 is caused from the deterioration of piercing strength of the separator due to the low melting point of the microporous polyethylene.

Further, when the heat shrinkability of the separator is large like the Sample 36, the separator is apt to be influenced by heat due to friction. Therefore, as the causes that the percent defective of the Sample 36 is high, there may be considered a friction between the electrode and the separator upon coiling a battery element, a damage applied to the separator due to frictional heat upon inserting the battery element into the battery can, that is, the generation of heat shrinkage in the separator due to the frictional heat or the deterioration of piercing strength of the separator.

Thus, there exists an optimum range in the melting point of the microporous polyethylene. As apparent from the Table 4, the melting point of the microporous polyethylene is preferably located within a range of 120° C. to 135° C. It is understood from the viewpoint of the maximum attainable temperature in battery that the melting point of the microporous polyethylene is more preferably located within a range of 125° C. to 135° C. Further, at this time, there exists an optimum range in the heat shrinkability of the separator. As apparent from the Table 4, the heat shrinkability of the separator is preferably located within a range not higher than 9.5%. It is understood from the viewpoint of the maximum attainable temperature in a battery that the heat shrinkability of the separator is more preferably located within a range not higher than 7.5%.

As recognized from the above description, when the polyolefin separator including the three layers of microporous polypropylene-microporous polyethylene-microporous polypropylene and having the thickness of the microporous polyethylene 60% as thick as the thickness of the separator is employed, the melting point of the microporous polyethylene is located within a range of 120° C. to 135° C. and the heat shrinkability of the separator is located within a range not higher than 9.5%, so that the cylindrical type nonaqueous electrolyte battery excellent from all the viewpoints of percent defective, maximum attainable temperature in a battery and load capacity maintaining/retention ratio can be more assuredly realized.

### [Experiment 5]

In an Experiment 5, the average particle size of the cathode active material was examined.

### [Sample 37]

In a Sample 37, a cylindrical type nonaqueous electrolyte battery was manufactured in the same manner as that of the Sample 31 except that the microporous polyethylene whose melting point was 125° C. was used and the heat shrinkability of the separator was 7.5%, the 90% cumulative pore size was 0.3 μm and the average particle size of the cathode active material was 1 μm.

### [Sample 38]

In a Sample 38, a cylindrical type nonaqueous electrolyte battery was manufactured in the same manner as that of the Sample 37 except that the average particle size of the cathode active material was 3 μm.

### [Sample 39]

In a Sample 39, a cylindrical type nonaqueous electrolyte battery was manufactured in the same manner as that of the Sample 37 except that the average particle size of the cathode active material was 5 μm.

### [Sample 40]

In a Sample 40, a cylindrical type nonaqueous electrolyte battery was manufactured in the same manner as that of the Sample 37 except that the average particle size of the cathode active material was 10 μm.

### [Sample 41]

In a Sample 41, a cylindrical type nonaqueous electrolyte battery was manufactured in the same manner as that of the Sample 37 except that the average particle size of the cathode active material was 20 μm.

### [Sample 42]

In a Sample 42, a cylindrical type nonaqueous electrolyte battery was manufactured in the same manner as that of the Sample 37 except that the average particle size of the cathode active material was 30 μm.

### [Sample 43]

In a Sample 43, a cylindrical type nonaqueous electrolyte battery was manufactured in the same manner as that of the Sample 37 except that the average particle size of the cathode active material was 35 μm.

The percent defective test, the external short-circuit test and the load capacity maintaining/retention ratio test were carried out in the same manner as the above relative to the cylindrical type nonaqueous electrolyte batteries of the Sample 37 to the Sample 43 manufactured as mentioned above to evaluate battery characteristics. Results thus obtained are shown in Table 5.

TABLE 5

| | | | | 90% |
|---|---|---|---|---|
| | PE | PP | Heat | Cumulative |
| | Melting Point | Melting Point | Shrinkability | Pore Size |
| | (° C.) | (° C.) | (%) | (μm) |
| Sample 37 | 125 | 165 | 7.5 | 0.3 |
| Sample 38 | 125 | 165 | 7.5 | 0.3 |
| Sample 39 | 125 | 165 | 7.5 | 0.3 |
| Sample 40 | 125 | 165 | 7.5 | 0.3 |
| Sample 41 | 125 | 165 | 7.5 | 0.3 |
| Sample 42 | 125 | 165 | 7.5 | 0.3 |
| Sample 43 | 125 | 165 | 7.5 | 0.3 |

| | Average | | Maximum | Load Capacity |
|---|---|---|---|---|
| | Particle | | Attainable | Maintaining/ |
| | size of Cathode | | Temperature in | retention |
| | Active Material | Percent | Battery | Ratio |
| | (μm) | Defective | (° C.) | (%) |
| Sample 37 | 1 | 7/50 | 94 | 62 |
| Sample 38 | 3 | 1/50 | 90 | 62 |
| Sample 39 | 5 | 0/50 | 89 | 59 |
| Sample 40 | 10 | 0/50 | 88 | 57 |
| Sample 41 | 20 | 0/50 | 87 | 52 |
| Sample 42 | 30 | 0/50 | 87 | 46 |
| Sample 43 | 35 | 0/50 | 87 | 28 |

As apparent from the Table 5, when the Sample 37 to the Sample 43 in the Table 5 are compared mutually, the Sample 37 in which the average particle size of the cathode active material is 1 μm has a percent defective higher than those of the Samples 38 to 42 in which the average particle size of the cathode active material is 3 μm or larger. This is considered to result from a fact that since the average particle size of the cathode active material of the Sample 37 is small as wide as 1 μm, the cathode active material enters the pores of the separator to come into contact with an anode electrode and generate a short-circuit. Further, the Sample 43 in which the average particle size of the cathode active material is 35 μm is not a defective article, however, low in its load capacity maintaining/retention ratio.

Thus, there exists an optimum range in the average particle size of the cathode active material. As understood from the Table 5, the average particle size of the cathode active material is preferably located within a range of 3 μm to 30 μm. Then, it is understood from the viewpoint of the load capacity maintaining/retention ratio that the average particle size of the cathode active material is more preferably located within a range of 3 μm to 20 μm.

As recognized from the above description, when the polyolefin separator including the three layers of microporous polypropylene-microporous polyethylene-microporous polypropylene and having the thickness of the microporous polyethylene 60% as large as the thickness of the separator is employed, the average particle size of the cathode active material is located within a range of 3 μm to 30 μm, so that the cylindrical type nonaqueous electrolyte battery excellent from all the viewpoints of percent defective, maximum attainable temperature in a battery and load capacity maintaining/retention ratio can be more assuredly realized.

### [Experiment 6]

In an Experiment 6, the melting point of the microporous polypropylene was examined.

### [Sample 44]

In a Sample 44, a cylindrical type nonaqueous electrolyte battery was manufactured in the same manner as that of the Sample 31 except that the microporous polyethylene whose melting point was 133° C. and the microporous polypropylene whose melting point was 153° C. were used and the 90% cumulative pore size of the separator was 0.5 μm.

### [Sample 45]

In a Sample 45, a cylindrical type nonaqueous electrolyte battery was manufactured in the same manner as that of the Sample 44 except that the microporous polypropylene whose melting point was 157° C. was used.

### [Sample 46]

In a Sample 46, a cylindrical type nonaqueous electrolyte battery was manufactured in the same manner as that of the Sample 44 except that the microporous polypropylene whose melting point was 160° C. was used.

### [Sample 47]

In a Sample 47, a cylindrical type nonaqueous electrolyte battery was manufactured in the same manner as that of the Sample 44 except that the microporous polypropylene whose melting point was 170° C. was used.

### [Sample 48]

In a Sample 48, a cylindrical type nonaqueous electrolyte battery was manufactured in the same manner as that of the Sample 44 except that the microporous polypropylene whose melting point was 172° C. was used.

### [Sample 49]

In a Sample 49, a cylindrical type nonaqueous electrolyte battery was manufactured in the same manner as that of the Sample 44 except that the microporous polypropylene whose melting point was 178° C. was used.

The percent defective test, the external short-circuit test and the load capacity maintaining/retention ratio test were carried out in the same manner as the above relative to the cylindrical type nonaqueous electrolyte batteries of the Sample 44 to the Sample 49 manufactured as mentioned above to evaluate battery characteristics. Results thus obtained are shown in Table 6.

TABLE 6

| | | | | 90% |
|---|---|---|---|---|
| | PE | PP | Heat | Cumulative |
| | Melting Point | Melting Point | Shrinkability | Pore Size |
| | (° C.) | (° C.) | (%) | (μm) |
| Sample 44 | 133 | 153 | 6 | 0.5 |
| Sample 45 | 133 | 157 | 5 | 0.5 |
| Sample 46 | 133 | 160 | 5 | 0.5 |
| Sample 47 | 133 | 170 | 3 | 0.5 |
| Sample 48 | 133 | 172 | 3 | 0.5 |
| Sample 49 | 133 | 178 | 3 | 0.5 |

| | Average | | Maximum | Load Capacity |
|---|---|---|---|---|
| | Particle | | Attainable | Maintaining/ |
| | size of Cathode | | Temperature in | retention |
| | Active Material | Percent | Battery | Ratio |
| | (μm) | Defective | (° C.) | (%) |
| Sample 44 | 15 | 4/50 | 90 | 56 |
| Sample 45 | 15 | 0/50 | 92 | 55 |
| Sample 46 | 15 | 0/50 | 93 | 55 |
| Sample 47 | 15 | 0/50 | 97 | 54 |
| Sample 48 | 15 | 0/50 | 99 | 56 |
| Sample 49 | 15 | 0/50 | 110 | 56 |

As apparent from the Table 6, when the Sample 44 to the Sample 49 in the Table 6 are compared mutually, the Sample 44 in which the melting point of the microporous polypropylene is 153° C. has a percent defective higher than those of the Sample 45 to Sample 48 in which the melting point of the microporous polypropylene ranges from 157° C. to 172° C. This is considered to result from a fact that the Sample 44 uses the microporous polypropylene whose melting point is low and the microporous polypropylene having the low melting point is lower in strength than the microporous polyethylene having a high melting point, so that the separator is pierced and broken. Further, it is understood that the Sample 49 in which the melting point of the microporous polypropylene is 178° C. has higher maximum attainable temperature in a battery than those of the Sample 45 to Sample 48 in which the melting point of the microporous polypropylene ranges from 157° C. to 172° C. This is considered to result from a fact that since the melting point of the microporous polypropylene is high, shut-down speed upon external short-circuit is slowed. Thus, there exists an optimum range in the melting point of the microporous polypropylene. As apparent from the Table 6, the melting point of the microporous polypropylene is preferably located within a range of 157° C. to 172° C.

As recognized from the above description, when the polyolefin separator including the three layers of microporous polypropylene-microporous polyethylene-microporous polypropylene and having the thickness of the microporous polyethylene 60% as large as the thickness of the separator is employed, the melting point of the microporous polypropylene is located within a range of 157° C. to 172° C., so that the cylindrical type nonaqueous electrolyte battery excellent from all the viewpoints of percent defective, maximum attainable temperature in a battery and load capacity maintaining/retention ratio can be more assuredly realized.

### [Experiment 7]

In an Experiment 7, the 90% cumulative pore size of the separator was examined.

### [Sample 50]

In a Sample 50, a cylindrical type nonaqueous electrolyte battery was manufactured in the same manner as that of the Sample 31 except that the 90% cumulative pore size of the separator was 0.01 μm.

### [Sample 51]

In a Sample 51, a cylindrical type nonaqueous electrolyte battery was manufactured in the same manner as that of the Sample 50 except that the 90% cumulative pore size of the separator was 0.02 μm.

### [Sample 52]

In a Sample 52, a cylindrical type nonaqueous electrolyte battery was manufactured in the same manner as that of the Sample 50 except that the 90% cumulative pore size of the separator was 0.04 μm.

### [Sample 53]

In a Sample 53, a cylindrical type nonaqueous electrolyte battery was manufactured in the same manner as that of the Sample 50 except that the 90% cumulative pore size of the separator was 1 μm.

### [Sample 54]

In a Sample 54, a cylindrical type nonaqueous electrolyte battery was manufactured in the same manner as that of the Sample 50 except that the 90% cumulative pore size of the separator was 2 μm.

### [Sample 55]

In a Sample 55, a cylindrical type nonaqueous electrolyte battery was manufactured in the same manner as that of the Sample 50 except that the 90% cumulative pore size of the separator was 4 μm.

The percent defective test, the external short-circuit test and the load capacity maintaining/retention ratio test were carried out in the same manner as the above relative to the cylindrical type nonaqueous electrolyte batteries of the Sample 50 to the Sample 55 manufactured as mentioned above to evaluate battery characteristics. Results thus obtained are shown in Table 7.

TABLE 7

| | | | | 90% |
|---|---|---|---|---|
| | PE | PP | Heat | Cumulative |
| | Melting Point | Melting Point | Shrinkability | Pore Size |
| | (° C.) | (° C.) | (%) | (μm) |
| Sample 50 | 133 | 165 | 3 | 0.01 |
| Sample 51 | 133 | 165 | 3 | 0.02 |
| Sample 52 | 133 | 165 | 3 | 0.04 |
| Sample 53 | 133 | 165 | 8 | 1 |
| Sample 54 | 133 | 165 | 9 | 2 |
| Sample 55 | 133 | 165 | 15 | 4 |

| | Average | | Maximum | Load Capacity |
|---|---|---|---|---|
| | Particle | | Attainable | Maintaining/ |
| | size of Cathode | | Temperature in | retention |
| | Active Material | Percent | Battery | Ratio |
| | (μm) | Defective | (° C.) | (%) |
| Sample 50 | 15 | 0/50 | 87 | 30 |
| Sample 51 | 15 | 0/50 | 89 | 46 |
| Sample 52 | 15 | 0/50 | 90 | 50 |
| Sample 53 | 15 | 1/50 | 98 | 65 |
| Sample 54 | 15 | 1/50 | 99 | 70 |
| Sample 55 | 15 | 6/50 | 111 | 75 |

As apparent from the Table 7, when the Sample 50 to the Sample 55 in the Table 7 are compared mutually, the Sample 50 in which the 90% cumulative pore size of the separator is 0.01 μm has a load capacity maintaining/retention ratio lower than those of the Samples 51 to 54 in which the 90% cumulative pore size of the separator ranges from 0.02 μm to 2 μm. This is considered to result from a fact that since the pores of the separator of the Sample 50 are small, lithium ions are prevented from being inserted thereinto or separated therefrom.

Further, it is understood that the Sample 55 in which the 90% cumulative pore size of the separator is 4 μm has a high percent defective. This is considered to result from a fact that since the 90% cumulative pore size of the separator of the Sample 55 is large, cathode materials and anode materials falling from electrodes cause to be short-circuited through the pores of the separator. Thus, there exists an optimum range in the 90% cumulative pore size. As apparent from the Table 7, the 90% cumulative pore size of the separator is preferably located within a range of 0.02 μm to 2 μm.

As recognized from the above description, when the polyolefin separator including the three layers of microporous polypropylene-microporous polyethylene-microporous polypropylene and having the thickness of the microporous polyethylene 60% as large as the thickness of the separator is employed, the 90% cumulative pore size of the separator is located within a range of 0.02 μm to 2 μm, so that the cylindrical type nonaqueous electrolyte battery excellent from all the viewpoints of percent defective, maximum attainable temperature in a battery and load capacity maintaining/retention ratio can be more assuredly realized.

As understood from the above description, the present invention is applied so that the temperature of the battery can be controlled and the nonaqueous electrolyte battery excellent in its reliability can be realized.

Now, a second embodiment of the present invention will be described. A nonaqueous electrolyte battery according to the second embodiment comprises two laminated layers of microporous films made of polyolefin in which the average pore size of the microporous film in a cathode side is larger than the average pore size of the microporous film in an anode side so that an ionic conductivity is improved and low temperature characteristics and cyclic characteristics are improved.

Further, in the separator, the average pore size of the microporous film in the anode side is relatively decreased, and accordingly, an internal short-circuit resulting from the entry of fine active materials falling from the electrodes to the pores of the separator is suppressed.

FIG. 2 shows a sectional structure of the nonaqueous electrolyte battery. This nonaqueous electrolyte battery is what is called a cylindrical type battery and has a spirally coiled electrode body formed by coiling many times an elongated cathode 22 having a cathode active material and an elongated anode 23 having an anode active material through a separator 24 having an ionic permeability in a substantially hollow and cylindrical battery can 21. The battery can 21 is composed of, for instance, iron plated with nickel. One end part of the battery can is closed and the other end part is opened. In the battery can 21, a pair of insulating plates 25 and 26 are respectively disposed perpendicularly to the peripheral surface of the spirally coiled electrode body so as to sandwich the spirally coiled electrode body in between the insulating plates 25 and 26.

To the open end part of the battery can 21, a battery cover 27 and a safety valve mechanism 28 and a positive temperature coefficient element (PTC element) 29 provided inside the battery cover 27 are caulked through a gasket 30 to be attached. The battery can 21 is sealed. The battery cover 27 is made of, for instance, a material similar to that of the battery can 21. The safety valve mechanism 28 is electrically connected to the battery cover 27 through the positive temperature coefficient element 29 and is provided with, what is called a current cutting-off mechanism for disconnecting the electric connection between the battery cover 27 and the spirally coiled electrode body, when the internal pressure of the battery reaches a prescribed value or more due to an internal short-circuit or external heating or the like. When temperature rises, the positive temperature coefficient element 29 serves to restrict current in accordance with the increase of a resistance value and prevent abnormal heat generation due to large current. The gasket 30 is made of, for instance, an insulating material. Asphalt is applied to the surface of the gasket 30.

The spirally coiled electrode body is coiled about, for instance, a center pin 31. A cathode lead 32 made of aluminum or the like is connected to the cathode 22 of the spirally coiled electrode body. To the anode 23, an anode lead 33 made of nickel or the like is connected. The cathode lead 32 is welded to the safety valve mechanism 28 so that it is electrically connected to the battery cover 27. The anode lead 33 is welded and electrically connected to the battery can 21. Further, the separator 24 between the cathode 22 and the anode 23 is impregnated with, for instance, electrolyte solution as nonaqueous electrolyte.

The separator 24 is a microporous film having many micropores and disposed between the cathode 22 and the anode 23 to prevent the physical contact therebetween and hold electrolyte solution in the pores. That is, the separator 24 absorbs the electrolyte solution so that lithium ions can pass through the separator upon charging and discharging operations.

In this embodiment, especially, the separator 24 has the structure that two layers of microporous films are laminated and the average pore size of the microporous film in the cathode side is larger than the average pore size of the microporous film in the anode side and the average pore size of the microporous film in the anode side is relatively decreased. Thus, the internal short-circuit resulting from the entry of the fine active materials falling from the electrodes to the pores of the separator 24 is suppressed and a percent defective upon production of the batteries is improved.

Further, since the average pore size of the microporous film in the cathode side forming the separator 24 is relatively large, a sufficient amount of electrolyte solution is supplied to the surface of the cathode 22 from the pores of the microporous film in the cathode side. Thus, the ionic conductivity of the cathode 22 made of a material which is ordinarily inferior in conductivity is improved and low temperature characteristics and cyclic characteristics are improved.

Here, it is important to use the microporous films the average pore sizes of which are different from each other as the two layers of the microporous films forming the separator 24. For instance, the movement of lithium ions in the separator is prevented only by reducing the average pore size of both the two layers of the microporous films to inconveniently deteriorate the low temperature characteristics and the cyclic characteristics. On the contrary, when the average pore size of the microporous film in the cathode side is small and the average pore size of the microporous film in the anode side is large, the amount of electrolyte solution held by the microporous film in the cathode side is decreased, so that the electrolyte solution is insufficiently supplied to the surface of the cathode from the separator. Generally, since the cathode is made of the material inferior in conductivity, the deterioration of the low temperature characteristics and the cyclic characteristics due to the shortage of electrolyte solution in the cathode appears more outstandingly than that when the electrolyte solution is insufficient in the anode.

In the separator 24, assuming that the average pore size of the microporous film in the cathode side is A and the average pore size of the microporous film in the anode side is B, the ratio of average pore size A to B is preferably 1.2 or larger and 10 or smaller, and more preferably, 1.3 or larger and 9 or smaller. The ratio of average pore size of the two layers of the microporous films is preset to the above-described range, so that the percent defective of the battery, the low temperature characteristics and the cyclic characteristics upon production of batteries can be more effectively and assuredly achieved.

On the other hand, when the ratio of average pore size A to B is smaller than 1.2, the low temperature characteristics and the cyclic characteristics are lowered. Further, when the ratio of average pore size A to B exceeds 10, the percent defective upon production of batteries is increased.

As the material forming the microporous films of the separator 24, for instance, polyolefin may be used. Polyethylene is preferably used as the microporous film in either the cathode side or the anode side, and polypropylene is preferably used as the other microporous film. As the microporous films forming the separator 24, for instance, when polypropylene is employed for both the two layers, a battery element is hardened, because polypropylene extends less than polyethylene. Thus, the degree of penetration of the electrolyte solution to all the battery element is lowered, so that the lithium ions are not smoothly inserted into the anode 23 upon initial charging to lower a battery capacity.

Especially, polyethylene is preferably used as the microporous film in the cathode side and polypropylene is preferably used as the microporous film in the anode side. Polypropylene having high strength is employed as the microporous film having the small average pore size arranged in the anode side, and accordingly, the collapse and bite of the pores due to the stress resulting from the expansion and shrinkage of the anode 23 are suppressed so that a productivity, and the low temperature characteristics and the cyclic characteristics are more improved.

The cathode 22 comprises, for instance, a cathode active material layer 22a including a cathode active material and a cathode current collector 22b. The cathode current collector 22b is composed of a metallic foil such as aluminum. The cathode active material layer 22a includes, for instance, the cathode active material, a conductive material such as graphite and a binding agent such as polyvinylidene fluoride. The cathode active material is not especially limited, however, preferably includes a sufficient amount of Li. For instance, there may be preferably used metal composite oxides including lithium and transition metals expressed by a general formula LiMₓO_{y} (in the formula, M designates at least one kind of element between Co, Ni, Mn, Fe, Al, V and Ti, or intercalation compounds including lithium.

The anode 23 has an anode active material layer 23a including an anode active material and an anode current collector 23b. The anode current collector 23b is composed of a metallic foil such as copper. As the anode active material, there may be preferably used a material capable of being electrochemically doped with or dedoped from lithium under the potential of 2.0 V or lower relative to metallic lithium.

Although the anode 23 using the material capable of being doped with and dedoped from lithium expands and shrinks upon charging and discharging operations more terribly than the anode 23 using, for instance, metallic lithium and the anode active materials are inconveniently liable to fall and enter the pores of the separator 24, according to the present invention, the anode 23 using the material capable of being doped with and dedoped from lithium is combined with the separator 24 in which the average pore size of the microporous film in the anode side is small as described above, so that the generation of an internal short-circuit resulting from the falling of the anode active materials can be prevented to improve a productivity.

As the materials capable of being doped with or dedoped from lithium, there may be exemplified carbon materials, for instance, non-graphitizable carbon, artificial graphite, natural graphite, pyrocarbons, coke (pitch coke, needle coke, petroleum coke, etc.), graphites, vitreous carbons, organic polymer compound sintered body (obtained by sintered a phenolic resin or a furan resin at suitable temperature and carbonizing it), carbon fibers, activated carbon, carbon black, etc. Moreover, metals capable of forming alloys with lithium and alloys thereof may be used. Furthermore, there may be used oxides capable of being doped with or dedoped from lithium under a relatively low potential such as iron oxide, ruthenium oxide, molybdenum oxide, tungsten oxide, titanium oxide, tin oxide, etc. Besides, other nitrides may be likewise used as the anode 23.

As nonaqueous electrolyte, there may be employed any of nonaqueous electrolyte solution obtained by dissolving electrolyte salt in a nonaqueous solvent, a solid electrolyte including electrolyte salt and a gel electrolyte having an organic polymer impregnated with a nonaqueous solvent and electrolyte salt.

The nonaqueous electrolyte solution among them is prepared by suitably combining the nonaqueous solvent with the electrolyte salt. Any of the nonaqueous solvents used for such batteries may be employed. As the nonaqueous solvents, there are exemplified, for instance, propylene carbonate, ethylene carbonate, vinylene carbonate, diethyl carbonate, dimethyl carbonate, 1, 2-dimethoxyethane, 1, 2-diethoxyethane, g-butyrolactone, tetrahydrofuran, 2-methyl tetrahydrofuran, 1, 3-dioxolane, 4-methyl-1, 3-dioxolane, diethyl ether, sulfolane, methyl sulfolane, acetonitrile, propionitrile, acetate, butyrate, propionate, etc.

As the solid electrolyte, any of inorganic solid electrolytes, solid polymer electrolytes or the like which are materials having a lithium ionic conductivity may be employed. As the specific inorganic solid electrolytes, there are exemplified lithium nitride, lithium iodide, etc. The solid polymer electrolyte comprises electrolyte salt and a polymer compound for dissolving it. As the polymer compounds, for instance, poly (ethylene oxide), or ether polymers such as bridged materials thereof, poly (methacrylate) esters, acrylate, etc. may be independently used or copolymerized or mixed in molecules to be used.

As organic polymers used for the gel electrolyte, there may be used various kinds of polymers which absorb organic solvents to gel. As the specific organic polymers, there may be employed fluorinated polymers such as poly (vinylidene fluoride), poly (vinylidene fluoride-co-hexafluoro propylene), etc. or ether polymers such as poly (ethylene oxide) or bridged materials thereof, poly (acrylonitrile), etc. Specially, fluorinated polymers are preferably employed from the viewpoint of oxidation-reduction stability. These organic polymers include electrolyte salts to obtain an ionic conductivity.

As the electrolyte salts, there may be used, for example, LiPF₆, LiClO₄, LiAsF₆, LiBF₄, LiB(C₆H₅)₄, CH₃SO₃Li, CF₃SO₃Li, LiCl, LiBr etc.

In this embodiment, a method for manufacturing the nonaqueous electrolyte battery is not especially limited. For example, as methods for manufacturing the cathode 22 and the anode 23, there may be employed various kinds of methods such as a method for adding a well-known binding agent or the like to the cathode active material or the anode active material, adding a solvent thereto and applying the obtained material to a current collector, a method for adding a well-known binding agent or the like to the cathode active material or the anode active material, heating the obtained material and applying it to a current collectors, a method for applying a molding process or the like to the active material alone or a mixture obtained by mixing the active material, a conductive material and a binding agent together to form a compact electrode, etc.

More specifically, the cathode active material or the anode active material is mixed with the binding agent and an organic solvent to have slurry, and the slurry is applied to a cathode current collector or an anode current collector and dried so that the cathode 22 or the anode 23 can be manufactured. Further, while the cathode active material or the anode active material is heated, the active material is molded by heating irrespective of the presence or absence of the binding agent to manufacture the cathode 22 or the anode 23 having high strength.

In the above description, although what is called a spirally coiled electrode body is described, which is manufactured by laminating a cathode and an anode through a separator and coiling the obtained laminated body about a core a plurality of times, the present invention is not limited thereto. For instance, the present invention may be applied to a laminated type battery manufactured by sequentially laminating electrodes and separators, etc. Further, when a prismatic type battery is manufactured, may be also employed a method for laminating an anode and a cathode through a separator and coiling the obtained laminated body about a core.

As described above, since the separator is composed of two layers of microporous films and the average pore size of the microporous film in the cathode side is larger than the average pore size of the microporous film in the anode side, the internal short-circuit resulting from the entry of the active materials falling from the electrode to the pores of the separator is suppressed and the ions in the separator are smoothly moved. Accordingly, the degradation of the battery resulting from the entry of the fine active materials falling from the electrodes to the pores is reduced to realize an excellent productivity.

Further, according to the present embodiment, since the average pore size of the microporous film in the cathode side is relatively large, a sufficient amount of electrolyte solution is supplied to the cathode which is ordinarily inferior in its conductivity so that the ionic conductivity of the cathode is improved. Therefore, the low temperature characteristics and the cyclic characteristics are improved.

In the above description, although the cylindrical nonaqueous electrolyte battery is described as an example, the configuration of the battery is not especially limited and various kinds of configurations such as a prismatic type, a coin type, a button type, a laminate type, etc. may be employed. Further, the present invention may be applied to a primary battery and a secondary battery.

Now, a third embodiment to which the present invention is applied will be described below.

Since a nonaqueous electrolyte battery shown as the third embodiment has the same construction as that of the nonaqueous electrolyte battery shown in FIG. 2 except that the separator of this embodiment is different from that of the second embodiment, the explanation of the construction except the separator is omitted.

The separator in the nonaqueous electrolyte battery according to the third embodiment has a structure that two layers of microporous films are laminated, the average pore size of the microporous film in an anode side is larger than the average pore size of the microporous film in a cathode side and the microporous film in the cathode side is made of polypropylene.

In this separator, the average pore size of one microporous film forming the separator, that is, the microporous film in the cathode side is decreased. Thus, the internal short-circuit resulting from the entry of fine active materials falling from the electrodes to the pores of the separator is suppressed and a percent defective upon production of the batteries is improved. Further, polypropylene having high strength is employed for the microporous film in the cathode side so that the percent defective upon production of the batteries can be improved.

Further, since the average pore size of the microporous film in the anode side forming the separator is relatively large, even when the microporous film is compressed due to the expansion and shrinkage of the anode upon charging and discharging operations, the pores of the microporous film are hardly clogged. Accordingly, the movement of ions upon charging and discharging operations is improved to enhance cyclic characteristics. It is important to use the microporous films the average pore sizes of which are different from each other as the two layers of microporous films forming the separator. The permeability of lithium ions is deteriorated, for instance, only by reducing the average pore sizes of both the two layers of the microporous films to inconveniently deteriorate the low temperature characteristics and the cyclic characteristics.

Accordingly, specifically, assuming that the average pore size of the microporous film in the cathode side of the separator is C and the average pore size of the microporous film in the anode side is D, the ratio of average pore size C to D is preferably 0.1 or larger and 0.83 or smaller, and more preferably, 0.2 or larger and 0.8 or smaller. The ratio of average pore size of the two layers of the microporous films is preset to the above-described range, so that the percent defective of the battery upon production and the cyclic characteristics can be more effectively and assuredly achieved. When the ratio of average pore size C to D is smaller than 0.1, the cyclic characteristics are lowered. Further, when the ratio of average pore size C to D exceeds 0.83, the percent defective upon production of batteries is increased.

As the material forming the microporous films of the separator, for instance, polyolefin may be used. Polyethylene is preferably used as the microporous film in either the cathode side or the anode side, and polypropylene is preferably used as the other microporous film. As the microporous films forming the separator, for instance, when polypropylene is employed for both the two layers, a battery element is hardened, because polypropylene extends less than polyethylene. Thus, the degree of penetration of the electrolyte solution to all the battery element is lowered, so that the lithium ions may not be possibly smoothly inserted into the anode upon initial charging to lower a battery capacity.

As described above, according to the present embodiment, the separator is composed of two layers of microporous films, the average pore size of the microporous film in the anode side is larger than the average pore size of the microporous film in the cathode side and the microporous film in the cathode side is made of polypropylene. Thus, since the average pore size of the microporous film in the anode side forming the separator is relatively large, even when the microporous film is compressed due to the expansion and shrinkage of the anode upon charging and discharging operations, the pores of the microporous film are hardly clogged. Accordingly, the movement of ions upon charging and discharging operations is improved to enhance cyclic characteristics.

Further, according to the present embodiment, since the degradation of the battery resulting from the entry of the fine active materials falling from the electrodes is reduced and the separator in the cathode side is made of polypropylene having high strength, an excellent productivity is realized.

### Example 2

Now, specific Examples to which the present invention will be explained on the basis of experimental results.

### [Experiment 8]

Firstly, a case in which a separator was composed of two layers of microporous films and the average pore size of a microporous film in a cathode side was larger than the average pore size of a microporous film in an anode side was examined.

### [Sample 61]

Firstly, an anode was manufactured as described below.

Coal tar pitch of 30 parts by weight as a binder was added to and mixed with coal coke of 100 parts by weight as a filler at about 100° C., and the mixture thus obtained was compression-molded by a press machine to obtain a precursor of a carbon compact. Then, the precursor was heat-treated at the temperature of 1000° C. or lower to obtain a carbon material compact. Further, what is called pitch impregnation/heat treatment processes that the carbon material compact was impregnated with binder pitch melted at 200° C. or lower and heat-treated under the condition of 1000° C. or lower were repeated several times. Then, the carbon compact was heat-treated in an inert atmosphere at 2800° C. to manufacture a graphitized compact. After that, the graphitized compact was pulverized and classified to have sample powder.

When an X-ray diffraction measurement for the graphite material obtained at this time was carried out, the interplanar spacing of (002) planes was 0.337 nm and the thickness of the C-axis crystallite of the (002) plane was 50.0 nm. True density obtained by a pycnometer method was 2.23. Further, a specific surface area obtained by BET method was 1.6 m²/g. In a particle size distribution obtained by a laser diffraction method, an average particle size was 33.0 μm, a 10% cumulative particle size was 13.3 μm, a 50% cumulative particle size was 30.6 μm and a 90% cumulative particle size was 55.7 μm. In addition, the average value of the fracture strength of the graphitized particles was 7.1 kgf/mm² and bulk density was 0.98 g/cm³.

The graphitized sample powder of 90 parts by weight was mixed with polyvinylidene fluoride (PVDF) of 10 parts by weight as a binding agent to prepare an anode composite mixture. Then, the anode composite mixture was dispersed in N-methylpyrrolidone as a solvent to have slurry (paste).

Then, the anode composite mixture slurry was uniformly applied to both the surfaces of an anode current collector and dried to form anode active material layers. Then, the anode active material layers were compression-molded under prescribed pressure to manufacture an elongated anode. As the anode current collector, an elongated copper foil having the thickness of 10 μm was used.

Subsequently, a cathode was manufactured. Lithium carbonate of 0.5 mol was mixed with cobalt carbonate of 1 mol and this mixture was sintered in air at the temperature of 950° C. for 5 hours. An X-ray diffraction measurement was carried out for the obtained material, so that the material had a peak completely corresponding to the peak of LiCoO₂ registered in the JCPDS file.

Then, the obtained LiCoO₂ was pulverized to have powder the average particle size of which was 19 μm. Then, LiCoO₂ powder of 95 parts by weight was mixed with lithium carbonate powder of 5 parts by weight to obtain a mixture. Further, the mixture of 91 parts by weight, scale graphite of 6 parts by weight as a conductive material and polyvinylidene fluoride of 3 parts by weight as a binding agent were mixed together to prepare a cathode composite mixture. The cathode composite mixture was dispersed in N-methylpyrrolidone to have slurry (paste).

Then, the cathode composite mixture slurry was uniformly applied to both the surfaces of a cathode current collector and dried to form cathode active material layers. Then, the cathode active material layers were compression-molded under prescribed pressure so that an elongated cathode was manufactured. As the cathode current collector, an elongated aluminum foil having the thickness of 20 μm was used.

Then, the elongated cathode and the elongated anode obtained in this manner were laminated through the separator comprising two layers of microporous polyethylene whose average pore size was 0.5 μm and whose thickness was 15 μm and microporous polyethylene whose average pore size was 0.1 μm and whose thickness was 15 μm, then stacked the anode, the separator, the cathode and the separator respectively. The obtained laminated body was coiled many times to obtain a spirally coiled electrode body having the outside diameter of 18 mm. The microporous polyethylene the average pore size of which was 0.5 μm was made to come into contact with the cathode. The microporous polyethylene the average pore size of which was 0.1 μm was made to come into contact with the anode. The average pore size of the separator was measured by a mercury porosimeter.

The spirally coiled electrode body was accommodated in a battery can made of iron plated with nickel. Then, insulating plates were disposed on both the upper limit surfaces of the spirally coiled electrode body, a cathode lead made of aluminum was drawn out from the cathode current collector and welded to a battery can and an anode lead made of nickel drawn out from the anode current collector and welded to the battery can. In the battery can, was injected electrolyte solution obtained by mixing LiPF₆, ethylene carbonate and dimethyl carbonate in the weight ratio 10:40:50.

Then, the battery can was caulked through an insulating sealing gasket having a surface to which asphalt was applied so that a safety valve device having a current cutting-off mechanism, a PTC element and a battery cover were fixed to the battery can to maintain the air-tightness of the battery. Thus, the cylindrical type nonaqueous electrolyte battery having the diameter of 18 mm and the height of 65 mm was manufactured.

### [Sample 62 to Sample 68]

Nonaqueous electrolyte batteries of Sample 62 to Sample 68 were manufactured in the same manner as that of the Sample 61 except that materials and average pore sizes shown in the following Table 8 were used for two layers of microporous films forming a separator.

The nonaqueous electrolyte batteries manufactured as mentioned above were evaluated in respect of percent defective, battery capacity at room temperature, low temperature characteristics and cyclic characteristics.

### 1. Test for Percent Defective

100 pieces of batteries of each Sample were prepared. A constant-current and constant-voltage charging operation was carried out relative to these batteries within 5 hours after the batteries were manufactured in an atmosphere of 23° C. under the conditions of upper limit voltage of 4.2 V, current of 0.3 A and 10 hours, and then the batteries were stored under the atmosphere of 23° C. for 1 month. An OCV measurement was carried out to these batteries to determine the batteries of 4.15 V or lower to be defective articles.

### 2. Test for Battery Capacity

A constant-current and constant-voltage charging operation was carried out relative to the batteries respectively determined to be good articles after the storage for 1 month in accordance with the above-described measurement of percent defective in a constant temperature vessel at 23° C. under the conditions of upper limit voltage of 4.2 V, current of 1 A and 3 hours. Then, a constant-current discharging operation of 0.8 A was carried out up to finish voltage of 3.0 V to measure battery capacity at this time.

### 3. Test for Low Temperature Characteristics

After a constant-current and constant-voltage charging operation was performed relative to each battery in a constant temperature vessel of 23° C. under the conditions of upper limit voltage of 4.2 V, current of 1 A and 3 hours, a constant-current discharging operation of 0.8 A was carried out up to the finish voltage of 3.0 V. Further, a constant-current and constant-voltage charging operation was performed relative to each battery under the conditions of upper limit voltage of 4.2 V, current of 1 A and 3 hours. Then, after the battery was left in a constant temperature vessel at −20° C. for 3 hours, a constant-current discharging operation of 0.8 A was carried out up to the finish voltage of 3.0 V to measure battery capacity at this time.

### 4. Test for Cyclic Characteristics

After a constant-current and constant-voltage charging operation was performed relative to each battery at ambient temperature under the conditions of upper limit voltage of 4.2 V, current of 1 A and 3 hours, a constant-current discharging operation of 0.8 A was carried out up to the finish voltage of 3.0 V. Such charging and discharging cycles were carried out 250 times. Assuming that a discharging capacity of a first cycle is 100%, a discharging capacity of 250 th cycle was calculated to determine the calculated value to be a capacity maintaining/retention ratio.

The evaluation results described above are shown in the Table 8. In the Table 8, polypropylene was designated by PP and polyethylene was designated by PE.

TABLE 8

| | Average pore | Average pore | | |
|---|---|---|---|---|
| | size in Cathode | size in Anode | Average pore | Separator |
| | Side | Side | size Ratio | Material in |
| | (μm) | (μm) | A/B | Cathode Side |
| Sample 61 | 0.5 | 0.1 | 5 | PE |
| Sample 62 | 0.2 | 0.1 | 2 | PE |
| Sample 63 | 0.5 | 0.1 | 5 | PE |
| Sample 64 | 0.5 | 0.1 | 5 | PP |
| Sample 65 | 0.5 | 0.1 | 5 | PP |
| Sample 66 | 0.1 | 0.5 | 0.5 | PE |
| Sample 67 | 0.1 | 0.1 | 1 | PE |
| Sample 68 | 0.5 | 0.5 | 1 | PE |

| | | | Battery | | Capacity |
|---|---|---|---|---|---|
| | | | Capacity at | Battery | Maintaining/Retention |
| | Separator | | Room | Capacity | Ratio |
| | Material in | Percent | Temperature | at −20° C. | of 250th Cycle |
| | Anode Side | Defective | (mAh) | (mAh) | (%) |
| Sample 61 | PE | 1/100 | 1601 | 680 | 77 |
| Sample 62 | PE | 1/100 | 1601 | 661 | 73 |
| Sample 63 | PP | 0/100 | 1600 | 675 | 92 |
| Sample 64 | PE | 1/100 | 1601 | 674 | 80 |
| Sample 65 | PP | 0/100 | 1589 | 661 | 80 |
| Sample 66 | PE | 6/100 | 1600 | 630 | 62 |
| Sample 67 | PE | 1/100 | 1599 | 550 | 59 |
| Sample 68 | PE | 14/100 | 1598 | 760 | 84 |

As apparent from the Table 8, the Sample 61 to Sample 65 in which the separator was made of two layers of microporous films and the average pore size of the microporous film in the cathode side was larger than the average pore size of the microporous film in the anode side showed good results from all the viewpoints of percent defective, battery capacity at room temperature, low temperature characteristics and cyclic characteristics and were excellent in productivity and battery characteristics.

On the other hand, the Sample 66 in which the microporous film in the cathode side and the microporous film in the anode side were made of polyethylene and the average pore size of the microporous film in the cathode side was smaller than the average pore size of the microporous film in the anode side showed a high value in view of percent defective of a battery. This is considered to result from a fact that since the expansion of an electrode in the anode upon charging is larger than that of the cathode, active materials are apt to fall so that an internal short-circuit is generated. Further, when the microporous film having the same average pore size was used in the cathode side and the anode side, the low temperature characteristics and the cyclic characteristics of the Sample 67 were lower than those of the Sample 61 to Sample 65 and the percent defective of the Sample 68 showed a large value.

Further, the Sample 63 had the most excellent evaluation results among the Sample 61 to Sample 65. It was understood from this result that polyethylene was preferably used as the microporous film in the cathode side and polypropylene was preferably used as the microporous film in the anode side.

### [Experiment 9]

Then, when the separator was made of two layers of microporous films and the average pore size of the microporous film in the cathode side was larger than the average pore size of the microporous film in the anode side, a preferable ratio of average pore size was examined.

### [Sample 69 to Sample 74]

Nonaqueous electrolyte batteries were manufactured in the same manner as that of the Sample 61 except that microporous films having average pore sizes as shown in Table 9 were used in the cathode side of the separator and assuming that the average pore size of the microporous film in the anode side was A and the average pore size of the microporous film in the cathode side was B, the ratios A to B of average pore size were values shown in the Table 9.

The Sample 69 to Sample 74 manufactured as described above were evaluated in the same manner as that of the Experiment 8 to evaluate the percent defective, the battery capacity at room temperature, the low temperature characteristics and the cyclic characteristics. The evaluation results are shown in the Table 9.

TABLE 9

| | Average pore | Average pore | | |
|---|---|---|---|---|
| | size in Cathode | size in Anode | Average pore | Separator |
| | Side | Side | size Ratio | Material in |
| | (μm) | (μm) | A/B | Cathode Side |
| Sample 69 | 0.12 | 0.1 | 1.2 | PE |
| Sample 70 | 0.13 | 0.1 | 1.3 | PE |
| Sample 71 | 0.7 | 0.1 | 7 | PE |
| Sample 72 | 0.9 | 0.1 | 9 | PE |
| Sample 73 | 1 | 0.1 | 10 | PE |
| Sample 74 | 1.5 | 0.1 | 15 | PE |

| | | | Battery | | Capacity |
|---|---|---|---|---|---|
| | | | Capacity at | Battery | Maintaining/Retention |
| | Separator | | Room | Capacity | Ratio |
| | Material in | Percent | Temperature | at −20° C. | of 250th Cycle |
| | Anode Side | Defective | (mAh) | (mAh) | (%) |
| Sample 69 | PE | 1/100 | 1602 | 630 | 71 |
| Sample 70 | PE | 1/100 | 1600 | 645 | 72 |
| Sample 71 | PE | 1/100 | 1599 | 698 | 80 |
| Sample 72 | PE | 2/100 | 1601 | 705 | 82 |
| Sample 73 | PE | 3/100 | 1600 | 714 | 84 |
| Sample 74 | PE | 39/100 | 1600 | 786 | 88 |

As apparent from the Table 9, the Sample 69 to the Sample 73 in which the ratio of average pore size A to B was located within a range of 1.2 or larger and 10 or smaller had better results in respect of percent defective than that of the Sample 74 in which the ratio of average pore size A to B was 15. Further, since the Sample 70 to the Sample 72 showed further better results, it was understood that the ratio of average pore size was more preferably 1.3 or larger and 9 or smaller.

### [Experiment 10]

Then, a case in which the separator was made of two layers of microporous films and the average pore size of the microporous film in the anode side was larger than the average pore size of the microporous film in the cathode side, and the microporous film in the cathode side was made of polypropylene was examined.

### [Sample 75, Sample 76]

Nonaqueous electrolyte batteries of Sample 75 and Sample 76 were manufactured in the same manner as that of the Sample 61 except that two layers of microporous films forming the separator having materials and average pore sizes as shown in Table 10 were used.

The Sample 75 and Sample 76 manufactured as described above were evaluated in the same manner as that of the Experiment 8 to perform the evaluations of the percent defective, the battery capacity at room temperature, the low temperature characteristics and the cyclic characteristics. The evaluation results thus obtained as well as the results of the Sample 66 to Sample 68 are shown in the following Table 10.

TABLE 10

| | Average pore | Average pore | | |
|---|---|---|---|---|
| | size in Cathode | size in Anode | Average pore | Separator |
| | Side | Side | size Ratio | Material in |
| | (μm) | (μm) | A/B | Cathode Side |
| Sample 75 | 1.1 | 0.5 | 0.5 | PP |
| Sample 76 | 0.1 | 0.5 | 0.5 | PE |
| Sample 66 | 0.1 | 0.5 | 0.5 | PE |
| Sample 67 | 0.1 | 0.1 | 1 | PE |
| Sample 68 | 0.5 | 0.5 | 1 | PE |

| | | | Battery | | Capacity |
|---|---|---|---|---|---|
| | | | Capacity at | Battery | Maintaining/Retention |
| | Separator | | Room | Capacity | Ratio |
| | Material in | Percent | Temperature | at −20° C. | of 250th Cycle |
| | Anode Side | Defective | (mAh) | (mAh) | (%) |
| Sample 75 | PE | 2/100 | 1600 | 615 | 78 |
| Sample 76 | PP | 2/100 | 1600 | 620 | 70 |
| Sample 66 | PE | 6/100 | 1600 | 630 | 62 |
| Sample 67 | PE | 1/100 | 1599 | 550 | 59 |
| Sample 68 | PE | 14/100 | 1598 | 760 | 84 |

As apparent from the Table 10, the Sample 75 in which the separator was made of two layers of microporous films and the average pore size of the microporous film in the anode side was larger than the average pore size of the microporous film in the cathode side and the microporous film in the cathode side is made of polypropylene showed good results from all the viewpoints of percent defective, battery capacity at room temperature, low temperature characteristics and cyclic characteristics and was excellent in productivity and battery characteristics.

On the other hand, the Sample 76 in which the microporous film in the cathode side in the cathode side was made of polyethylene was inferior in view of cyclic characteristics.

Further, the Sample 66 in which the microporous film in the cathode side and the microporous film in the anode side were made of polyethylene and the average pore size of the microporous film in the cathode side was smaller than the average pore size of the microporous film in the anode side showed a higher value in view of percent defective of a battery than that of the Sample 75. This is considered to result from a fact that since the expansion of an electrode upon charging is larger in the anode than that in the cathode, active materials are apt to fall so that an internal short-circuit is generated. Further, when the microporous films having the same average pore size were used in the cathode side and the anode side, the low temperature characteristics and the cyclic characteristics of the Sample 67 were lower than those of the Sample 75 and the percent defective of the Sample 68 showed a large value.

### [Experiment 11]

Then, when the separator was made of two layers of microporous films and the average pore size of the microporous film in the anode side was larger than the average pore size of the microporous film in the cathode side and the microporous film in the cathode side is made of polypropylene, a preferable ratio of average pore size was examined.

### [Sample 77 to Sample 81]

Nonaqueous electrolyte batteries were manufactured in the same manner as that of the Sample 61 except that microporous films having average pore sizes as shown in Table 11 were used in the cathode side of the separator and assuming that the average pore size of the microporous film in the anode side was C and the average pore size of the microporous film in the cathode side was D, the ratios C to D of average pore size were values shown in the Table 11.

The Sample 77 to Sample 81 manufactured as described above were evaluated in the same manner as that of the Experiment 8 to carry out the evaluations of the percent defective, the battery capacity at room temperature, the low temperature characteristics and the cyclic characteristics. The evaluation results are shown in the Table 11.

TABLE 11

| | Average pore | Average pore | | |
|---|---|---|---|---|
| | size in Cathode | size in Anode | Average pore | Separator |
| | Side | Side | size Ratio | Material in |
| | (μm) | (μm) | A/B | Cathode Side |
| Sample 77 | 0.1 | 0.12 | 0.83 | PP |
| Sample 78 | 0.1 | 0.13 | 0.77 | PP |
| Sample 79 | 0.1 | 0.9 | 0.11 | PP |
| Sample 80 | 0.1 | 1 | 0.1 | PP |
| Sample 81 | 0.1 | 1.5 | 0.067 | PP |

| | | | Battery | | Capacity |
|---|---|---|---|---|---|
| | | | Capacity at | Battery | Maintaining/Retention |
| | Separator | | Room | Capacity | Ratio |
| | Material in | Percent | Temperature | at −20° C. | of 250th Cycle |
| | Anode Side | Defective | (mAh) | (mAh) | (%) |
| Sample 77 | PE | 0/100 | 1602 | 622 | 70 |
| Sample 78 | PE | 0/100 | 1602 | 637 | 73 |
| Sample 79 | PE | 3/100 | 1600 | 650 | 84 |
| Sample 80 | PE | 3/100 | 1601 | 661 | 85 |
| Sample 81 | PE | 13/100 | 1599 | 780 | 88 |

As apparent from the Table 11, the Sample 77 to the Sample 80 in which the ratio of average pore size C to D was located within a range of 0.1 or larger and 0.83 or smaller had better results in respect of percent defective than that of the Sample 81 in which the ratio of average pore size C to D was 0.067. Further, it was understood that the ratio of average pore size C to D was more preferably 0.2 or larger and 0.8 or smaller in order to obtain further better results from all the viewpoints of percent defective, battery capacity at room temperature, low temperature characteristics and cyclic characteristics.

### INDUSTRIAL APPLICABILITY

A nonaqueous electrolyte battery according to the present invention comprises a cathode having a cathode active material, an anode having an anode active material, a nonaqueous electrolyte and a separator disposed between the cathode and the anode, and the separator has a plurality of microporous films made of polyolefin laminated. The plural microporous films include a first microporous film and a second microporous film in which the thickness of layers or the average pore size of the pores of the films to be laminated is respectively different from each other.

Especially, the separator has three or more layers of microporous films made of polyolefin laminated, the outermost layer of the separator is made of porous polypropylene, at least one layer of inner layers sandwiched in between the outermost layers is made of porous polyethylene, and the total of the thickness of the layers made of the porous polyethylene is located within a range of 40% to 84% as large as the thickness of the separator. Thus, in the nonaqueous electrolyte battery according to the present invention, the separator has a sufficient strength, and even when the internal temperature of the battery rises due to an external short-circuit or the like, the separator absorbs heat in the battery to suppress a chemical reaction in the battery, so that the temperature of the battery is assuredly lowered.

Further, in a nonaqueous electrolyte battery according to the present invention, a separator is composed of two laminated layers of microporous films made of polyolefin and the average pore size of the microporous film in the cathode side is larger than the average pore size of the microporous film in the anode side. Thus, an internal short-circuit resulting from the entry of the active materials falling from the anode and the cathode to the pores is prevented and ions in the separator are smoothly moved. Further, when the average pore size of the microporous film in the cathode side is relatively large, nonaqueous electrolyte can be more maintained than the anode side. Accordingly, the nonaqueous electrolyte is sufficiently supplied to the cathode which is ordinarily inferior in conductivity so that an ionic conductivity in the cathode can be ensured.

Further, in the nonaqueous electrolyte battery according to the present invention, since the average pore size of the microporous film in the anode side is larger than the average pore size of the microporous film in the cathode side and the microporous film in the cathode side is made of polypropylene, the pores of the separator in the cathode side are prevented from collapsing due to the expansion and shrinkage of an electrode upon charging. Accordingly, even when charging and discharging cycles are repeated, the average pore size in the cathode side is maintained and a sufficient amount of electrolyte solution is supplied to the surface of the cathode so that the ionic conductivity in the cathode can be ensured.

What is claims is:

1. A battery comprising:
a cathode with a cathode active material;
an anode; and
a separator disposed between the cathode and the anode,
wherein,
the separator has three or more layers,
the separator has a cathode-side microporous film on the cathode side of the separator and an anode-side microporous film on the anode side of the separator,
a ratio of an average pore size in μm of pores in the cathode-side microporous film to an average pore size in μm of pores in the anode-side microporous film is 1.2 or more and 10 or less,
a porosity of the separator is 30% to 50%, both inclusive,
a 90% cumulative pore size of the separator is from 0.02 μm to 2.0 μm, both inclusive,
at least one layer between the cathode-side microporous film and the anode-side microporous film is made of polyethylene, a total of the thickness of all layers made of polyethylene being 40% to 84% of an overall thickness of the separator, and
a average particle size of particles of the cathode active material is 3 um to 30 um.

2. The battery according to claim 1, wherein the ratio of the average pore size in μm of the pores in the cathode-side microporous film to the average pore size in μm of the pores in the anode-side microporous film is 1.2 or more and 5 or less.

3. The battery according to claim 1 or claim 2 is a non-aqueous electrolyte battery.

4. The battery according claim 1, wherein the cathode-side microporous film is a polyethylene film and the anode-side microporous film is a polypropylene film.

5. The battery of claim 2, wherein the ratio of the average pore size in μm of the pores in the cathode side microporous film to the average pore size in μm of the pores in the anode-side microporous film is 1.2 or more and 2 or less.

6. A battery comprising:
a cathode with a cathode active material;
an anode; and
a separator disposed between the cathode and the anode,
wherein,
the separator has three or more layers,
the separator has at least a cathode-side microporous film adjacent to the cathode and an anode-side microporous film adjacent to the anode,
a ratio of an average pore size in μm of pores the cathode-side microporous film to an average pore size in μm of pores in the anode-side microporous film is 0.1 or more and 0.83 or less,
a porosity of the separator is 30% to 50%, both inclusive,
a 90% cumulative pore size of the separator is from 0.02 μm to 2.0 μm, both inclusive,
at least one layer between the cathode-side microporous film and the anode-side microporous film is made of polyethylene, a total of the thickness of all layers made of polyethylene being 40% to 84% of an overall thickness of the separator, and
an average particle size of particles of the cathode active material is 3 μm to 30 μm.

7. The battery according to claim 6, wherein the anode-side microporous film is made of polyethylene and the cathode-side microporous film is made of polypropylene.

8. The battery of claim 4 or claim 7, wherein the polyethylene film has the larger average pore size than that of the polypropylene film.

9. The battery of claim 4 or claim 7, wherein the polyethylene has a melting point of from 120° C. to 135° C.

10. The battery of claim 1 or claim 6, wherein one of the layers of the separator is made of polyethylene with a melting point of from 120° C. to 135° C.

11. The battery according to claim 1 or claim 6, wherein at least the cathode-side microporous film or the anode-side microporous film comprises polyethylene or polypropylene.

12. The battery according to claim 1 or claim 6, wherein a thickness of the separator is 15 um or more and 40 um or less.

13. The battery according to claim 1 or claim 6, wherein a thickness of at least one of the outermost layers is 2 μm or more.

14. The battery according to claim 1 or claim 6, wherein the separator has a heat shrinkability of 10% over.

15. An electronic device comprising the battery according to claim 1 or claim 6.
